(19) United States
(12) Patent Application Publication
(10) Pub. No.: US 2022/0260441 A1
(43) Pub. Date: Aug. 18, 2022

(54) ELECTRONIC HAIL PAD

(71) Applicant: Understory, Inc., Madison, WI (US)

(72) Inventors: Bryan A. Dow, Monona, WI (US); John P. Leonard, Cambridge, WI (US)

(21) Appl. No.: 17/630,568

(22) PCT Filed: Jul. 28, 2020
(86) PCT No.: PCT/US2020/043891

§ 371 Date: Jan. 27, 2022

Related U.S. Application Data
(60) Provisional application No. 62/879,764, filed on Jul. 29, 2019.

(51) Int. Cl. G01L 5/00; G01P 15/08; G01W 1/04

(52) U.S. Cl. CPC G01L 5/0052; H02S 40/30; G01W 1/04; G01P 15/0891

(57) ABSTRACT

Provided herein is technology relating to measuring and recording weather phenomena and particularly, but not exclusively, to apparatuses, methods, kits, and systems for measuring hydrometeor impacts, e.g., hail impacts.

This application claims priority to U.S. provisional patent application Ser. No. 62/879,764, filed Jul. 29, 2019, which is incorporated herein by reference in its entirety.

### FIELD

Provided herein is technology relating to measuring and recording weather phenomena and particularly, but not exclusively, to apparatuses, methods, kits, and systems for measuring hydrometeor impacts, e.g., hail impacts.

### BACKGROUND

Measurements of hydrometeor impacts (e.g., hail) are used by numerous entities such as government agencies and a variety of industries. For example, some industries that collect hydrometeor impact data include those related to agriculture, insurance, and research. A variety of different devices and sensors for measuring hydrometeor impacts (e.g., hail impacts) are available. These devices and sensors vary in their detection mechanism as well as their resolution and accuracy. Measurements of hail are often made using a hailpad made from expanded polystyrene foam covered in heavy duty aluminum foil or latex paint. See, e.g., Long et al. (1980) “The Hailpad: Materials, Data Reduction and Calibration” Journal of Applied Meteorology 19: 1300. Mechanical sensors measure the impact of a hailstone on the instrument to estimate the magnitude of the strike or the frequency of occurrence of strikes. Even more sophisticated sensors use imaging techniques to measure occlusions of a hailstone over time and use these data to determine the size and velocity of hailstones.

Conventional hail sensing devices are limited in one or more ways. For example, foam hailpads absorb hailstone impacts inelastically and permanently and require regular and frequent replacement. Presently available mechanical, electronic, or imaging based hail pads often have a high cost of construction, installation, and/or repair that prevents wide-scale deployment for improved hail reporting. Accordingly, robust and lower cost technologies are needed to improve the measurement of hail impacts and provide hail impact data.

### SUMMARY

Accordingly, provided herein is a hail sensing technology that measures the acceleration of a body with respect to a fixed surface to measure the momentum, size, and/or velocity of a hailstone. In some embodiments, the technology provides an apparatus that senses hail impacts directly using a mechanical sensor and mechanical sensing method. For example, in some embodiments, the technology measures the impact of a hailstone directly on a planar surface (henceforth called a “detection plate”).

When detecting hail using previous technologies, fracture of hail upon impact transfers momentum from the intact hail to hail fragments rather than transferring momentum of the intact hail to the hail sensor. Further, some of the hail fragments produced upon impact escape away from the apparatus and are not detected, thus decreasing the accuracy of the hail sensing device to report hail impacts and hail characteristics.

In contrast, in some embodiments, the detection plate of the hail detection apparatus described herein further comprises an elastic cover component that increases the reliability and accuracy of measuring hailstones over a range of sizes (e.g., hail having a diameter of 0.5 to 2.5 inches or more). In particular, the elastic cover serves as a dampening component that slows the speed of hail impacting the apparatus, e.g., below the speed that causes fracture of hail upon impact (e.g., below the yield (e.g., fracture) stress limit for the hail). Accordingly, in some embodiments, the elastic cover minimizes and/or eliminates the fracture of hail impacting the apparatus, thus improving the detection of intact (e.g., whole, unfractured) hailstones and improving the accuracy of measuring the speed, mass, momentum, volume, and/or velocity of hail impacting the apparatus. Thus, embodiments of the hail sensing apparatus comprising an elastic cover maximize transfer of momentum from impacting hail to the hail sensing apparatus (e.g., to the sensors of the hail sensing apparatus) and thus improve the accuracy of hail impact measurements (e.g., measurements of hail speed, mass, momentum, volume, and/or velocity).

During the development of embodiments of the technology described herein, experimental data were collected that indicated that minimizing and/or eliminating the fracture of a hailstone upon impact with a hail detection apparatus as described herein is provided by an elastic cover having a thickness that is at least approximately half the diameter of an impacting hail stone. Accordingly, some embodiments of the technology comprise an elastic cover that is 0.2 to 2 inches thick (e.g., 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, or 3.0 inches thick). In some embodiments, the elastic cover has a thickness that is half the diameter of the historical mean hail diameter for a location where the hail sensing apparatus is installed. In some embodiments, the elastic cover has a thickness that is 50% to 90% of the historical maximum size hail diameter for a location where the hail sensing apparatus is installed. Further, fracture of a hail stone also depends on the peak pressure that a given hailstone can sustain (yield stress), which is determined by the composition of the hail stone (e.g., amount of water, ice, dirt, and other components), the temperature of the hailstone, and/or the shape of the hailstone. And, experimental data indicates that the yield stress for a given hailstone may vary by an order of magnitude. Thus, in some embodiments, the apparatus comprises an elastic cover that is 1.1, 1.2, 1.3, 1.4, 1.5, 1.6, 1.7, 1.8, 1.9, or 2.0× thicker than the thickness calculated for minimizing and/or eliminating hail fracture of hail having a typical range of diameters and/or having a typical composition and/or having a typical yield stress (fracture) point. Accordingly, in some embodiments, the hail sensing apparatus comprises an elastic cover to provide a hail sensing apparatus that reliably measures the impact force, or energy, of hail by limiting the impact force of each hailstone to below its fracture limit.

In some embodiments, the technology provides a component (e.g., an elastic cover) that provides high frequency damping of the hail detection apparatus. In some embodiments, the technology comprises actively controlling the height of the detection plate (e.g., solar panel) to thereby slow a hailstone instead of providing a static impact surface, e.g., by moving the detection plate in the direction of hailstone movement. In some embodiments, the technology comprises detecting a hailstone in flight and moving the detection plate prior to and/or simultaneously with hailstone impact. In some embodiments, the technology comprises estimating the size of a hailstone in flight and moving the detection plate prior and/or simultaneously with hailstone impact for hailstones that are greater than a hail stone diameter threshold (e.g., predicted to cause fracture of a hailstone impacting a static detection plate), e.g., greater than 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, or 2.5 inches in diameter.

In some embodiments, the apparatus comprises a component to provide mechanical damping (e.g., high frequency damping) of the detection plate. In some embodiments, the apparatus comprises mounting brackets that include a component to provide mechanical damping (e.g., high frequency damping) of the detection plate. In some embodiments, the apparatus (e.g., mounting brackets) comprise a magnetic air bearing to provide damping (e.g., high frequency damping) of the detection plate.

Additionally, in some embodiments, the technology comprises apparatuses and systems comprising a combination of a power system, a solar panel, and the detection plate. In some embodiments, this combination provides a device configured for deployment in remote locations, e.g., locations distant from a power source, locations that are difficult to access, and/or locations to which transport of materials is difficult. Accordingly, in some embodiments, the technology provides a hail sensor that is configured for deployment using minimal materials and tools.

In some embodiments, the detection plate is designed and/or provided to have a stiffness and/or a mass that decreases the contribution of detection plate flexure and vibration to the signal detected by the hail sensing apparatus upon hail impact. Accordingly, in some embodiments, an apparatus comprising a detection plate designed and/or provided to have a stiffness and/or a mass that decreases the contribution of detection plate flexure and vibration provides an improved detection of hail impacts and an improved accuracy of measuring hail size, momentum, mass, volume, speed, peak stress (e.g., peak force and/or peak acceleration), and/or velocity.

In some embodiments, the detection plate is a rigid detection plate that is fully instrumented to measure local forces on short (e.g., nanosecond, microsecond, or millisecond) timescales. In some embodiments, the rigid detection plate comprises force sensors capable of measuring the total force and position of a hailstone strike (e.g., a grid or mosaic array of small solid-state force sensors, or a pressure sensitive screen, among others). In some embodiments, the rigid detection plate comprises instrumentation that detects forces on the detection plate and/or acceleration of the detection plate at short time scales (e.g., 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁷ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁶ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁵ seconds or slower) by sampling at a sufficiently high rate (e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)) to provide improved peak stress measurements of force and/or acceleration. In some embodiments, the rigid detection plate comprises an analog-to-digital converter capable of sampling at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz).

In some embodiments, the surface of the detection plate is covered with a soft, elastic material that prevents the hailstone from breaking apart upon impact. Accordingly, in embodiments comprising an elastic cover component, hailstones strikes on the detection plate are elastic collisions, essentially elastic collisions, substantially elastic collisions, and/or are detectably elastic collisions. Thus, in embodiments comprising an elastic cover component, the kinetic energy of hailstones is conserved, essentially conserved, substantially conserved, and/or detectably conserved throughout the impact of the hailstone with the detection plate comprising the elastic cover component. Accordingly, in some embodiments, measurements of impact force and/or impact energy are have improved accuracy relative to measurements obtained without an elastic cover component because the measured kinetic energy of the collision represents more accurately the kinetic energy of the impactor (e.g., hydrometeor (e.g., hail stone)). Thus, in some embodiments, the kinetic energy transferred to the detection plate accurately represents the kinetic energy of the impactor (e.g., hydrometeor (e.g., hail stone)) at the moment of impact.

In some embodiments, the device directly measures the acceleration or force on the detection plate caused by a hailstone impact. In some embodiments, the device directly measures the peak stress (e.g., peak force and/or peak acceleration) of a hailstone impact. In some exemplary embodiments, the sensors used to measure the acceleration of the device and/or force on the device are microelectromechanical systems (MEMS) devices (e.g., accelerometers). In some embodiments, the sensors used to measure the acceleration of the device and/or force on the device are strain gauges. In these various embodiments, the force and/or acceleration is sampled at a high frequency (e.g., 8 to 42 kHz (e.g., 8 to 12 kHz (e.g., 8, 8.2, 8.4, 8.6, 8.8, 9.0, 9.2, 9.4, 9.6, 9.8, 10.0, 10.2, 10.4, 10.6, 10.8, 11.0, 11.2, 11.4, 11.6, 11.8, or 12.0 kHz), 28 to 42 kHz (e.g., 28, 29, 30, 31, 32, 33, 34, 35, 36, 37, 38, 39, 40, 41, or 42 kHz), and/or 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, and/or 42 kHz)) and the characteristics of the acceleration and/or force impulses measured during a hailstone strike are used to characterize the hailstone.

In some embodiments, the force and/or acceleration is sampled at an ultra-high frequency (e.g., 100-1000 kHz (e.g., 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 kHz or more) to provide a time resolution for observing the force and/or acceleration at the peak stress of the hailstone. In some embodiments, the hailstone detection device comprises an analog-to-digital convertor that samples the force and/or acceleration signals at an ultra-high frequency (e.g., 100-1000 kHz (e.g., 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, or 1000 kHz or more).

For example, when a hailstone impacts a large solid object (e.g., embodiments of a hail detection device as provided herein), both the ice (impactor) and object (target) respond in different ways. The impactor is quickly slowed and eventually stopped by the object. During this time, the impactor can be subject to large forces that cause it to deform elastically. Sufficiently high forces may fracture the impactor (e.g., hailstone). Further, the length of time the impactor contacts the target is typically very short for most hail strikes (e.g., approximately 100 milliseconds or shorter (e.g., less that 110, 105, 100, 95, 90, 85, 80, 75, 70, 65, 60, 55, 50, 45, 40, 35, 30, 25, or 20 milliseconds). After contact, the stone will either shatter or elastically rebound from the surface. Without being bound by theory, numerical solid mechanics modeling suggests that these contact forces may reach 10000 Newtons (N) or higher (e.g., more than 10,000; 11,000; 12,000; 13,000; 14,000; 15,000; 16,000; 17,000; 18,000; 19,000; 20,000; 21,000; 22,000; 23,000; 24,000; 25,000; 26,000; 27,000; 28,000; 29,000; 30,000; 31,000; 32,000; 33,000; 34,000; 35,000; 36,000; 37,000; 38,000; 39,000; 40,000; 41,000; 42,000; 43,000; 44,000; 45,000; 46,000; 47,000; 48,000; 49,000; or 50,000 N) for a hailstone of approximately 25 mm (e.g., 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 mm) diameter striking a hard surface.

As hailstones are generally round or possibly lobed, the point of contact with the target is usually quite small, which may produce a large stress concentration in the impactor and in the target. Without being bound by theory, local stresses in models have been shown to reach 100 mega-Pascals (MPa) (e.g., approximately 80-120 MPa (e.g., 80, 85, 90, 95, 100, 105, 110, 115, or 120 MPa)), which can cause fractures in the ice and/or plastic deformation or fracture in the target.

Accordingly, the maximum (“peak”) stress that a hailstone can withstand is an important parameter that determines the peak impact force and/or acceleration produced by the hailstone on the hailstone detection device and, consequently, determines the damage produced by a hailstone. Natural hailstones form under many different conditions in clouds and have widely different fracture strengths from storm to storm or even from stone to stone. Nonetheless, research has established that most natural hailstones will fracture at stresses ranging from approximately 3 to 30 MPa (e.g., approximately 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 MPa).

Accordingly, embodiments of the technology provided herein measure the peak stress (e.g., the peak force and/or peak acceleration caused by a hailstone impact) of a hailstone impactor (e.g., to characterize the impact of a hailstone), which is directly correlated to damage produced by the hailstone impacting an object. In contrast to the present technology, most previous technologies record measurements limited to hailstone size, incoming velocity, kinetic energy, or total momentum transferred during the impact, and have not measured peak stress (e.g., peak force and/or peak acceleration). While peak stress (e.g., peak force and/or peak acceleration) is sometimes observed to increase with one or more of these parameters, peak stress (e.g., peak force and/or peak acceleration) is not necessarily directly correlated to any of them because the specific deformation and losses in the impactor and target occur in only a small localized region and over a short time during contact.

Accordingly, embodiments of the hail detection device comprise a rigid detection plate that is fully instrumented to measure local forces on short (e.g., nanosecond, microsecond, or millisecond) timescales. In some embodiments, the hail detection device comprises a plate comprising force sensors capable of measuring the total force and position of a hailstone strike (e.g., a grid or mosaic array of small solid-state force sensors, or a pressure sensitive screen, among others). Furthermore, embodiments of the hail detection device comprise instrumentation that detects forces on the detection plate and/or acceleration of the detection plate at short time scales (e.g., 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁷ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁶ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁵ seconds or slower) by sampling at a sufficiently high rate (e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)) to provide peak stress measurements of force and/or acceleration. In addition, some embodiments comprise use of quantitative numerical models to estimate peak stress (e.g., peak force and/or peak acceleration) during the impact. In some embodiments, these quantitative numerical models are fit to known measurements such as incoming kinetic energy or momentum transferred to the instrumentation pad. In some embodiments, force and/or acceleration on the hail detection plate are sampled at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz) to produce ultra-high-sample rate data. In some embodiments, the ultra-high-sample rate data are continuously buffered and used (e.g., for additional calculations), transmitted, and/or evaluated only when a hailstone is detected.

In some embodiments, the hail detection device comprises an analog-to-digital converter capable of sampling signals output by the hail detection plate and/or sensors connected to the hail detection plate at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz). In some embodiments, the hail detection device comprises an analog-to-digital converter capable of sampling signals output by an array of sensors provided on the hail detection plate (e.g., a grid or mosaic array of small solid-state force sensors or a pressure sensitive screen) at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz).

Various embodiments relate to providing power to the device. In some embodiments, the body of the device (e.g., the detection plate) is a planar rigid body. In some embodiments, the body of the device (e.g., the detection plate) is a solar panel. In some embodiments, the detection plate comprises a solar panel. In some embodiments comprising a solar panel and an elastic component covering said solar panel, the elastic covering component covering the solar panel is sufficiently transparent to light (e.g., sunlight) and/or is sufficiently transparent to the appropriate wavelengths of light (e.g., sunlight) used by the solar panel to produce electricity, e.g., to provide power to the hail detection apparatus. In some embodiments, the body of the device comprises a rigid material and power is supplied from an external component, e.g., a solar panel, battery, or alternating current source.

Accordingly, provided herein is an apparatus comprising a detection plate and a sensor affixed to the underside of said detection plate. In some embodiments, the apparatus further comprises an elastic covering component. In some embodiments, the elastic covering component partially covers the top of the detection plate. In some embodiments, the elastic covering component fully covers the top of the detection plate. In some embodiments, the elastic covering component comprises a rubber, foam, membrane, meshed material, or net. In some embodiments, the elastic covering component permits transmission of light. In some embodiments, the elastic covering component permits transmission of sunlight. In some embodiments, the elastic covering component permits transmission of electromagnetic radiation having a wavelength between approximately 350 to 750 nm (e.g., a wavelength of approximately 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, 700, 705, 710, 715, 720, 725, 730, 735, 740, 745, or 750 nm). In some embodiments, the elastic covering component permits transmission of electromagnetic radiation having a wavelength between approximately 300 to 1100 nm (e.g., a wavelength of approximately 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, or 1100 nm). In some embodiments, the elastic covering component permits transmission of light sufficient to produce electric current by a photovoltaic panel. In some embodiments, the elastic covering component transmits approximately 20, 25, 30, 35, 40, 45, 50, 55, 60, 65, 70, 75, 80, 85, 90, 95, or 100% of the electromagnetic radiation contacting it. In some embodiments, the elastic covering component transmits approximately 20, 25, 30, 35, 40, 45, 50, 55, 60, 65, 70, 75, 80, 85, 90, 95, or 100% of a selected wavelength or range of wavelengths of electromagnetic radiation contacting it. In some embodiments, the elastic covering component comprises silicone.

In some embodiments, the detection plate comprises a solar panel (e.g., a photovoltaic cell). In some embodiments, the detection plate comprises a solid plate (e.g., steel (e.g., stainless steel), aluminum, metal alloy, plastic, or other solid plate material) and comprises solar cells adhered to the surface of the solid plate. In some embodiments, the detection plate is a rigid detection plate comprising force sensors capable of measuring the total force and position of a hailstone strike (e.g., a grid or mosaic array of small solid-state force sensors, or a pressure sensitive screen, among others). In some embodiments, the rigid detection plate comprises instrumentation that detects forces on the detection plate and/or acceleration of the detection plate at short time scales (e.g., 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁷ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁶ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁵ seconds or slower) by sampling at a sufficiently high rate (e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)) to provide peak stress (e.g., peak force and/or peak acceleration) measurements of force and/or acceleration. In some embodiments, the rigid detection plate comprises an analog-to-digital converter capable of sampling at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz).

In some embodiments, the sensor is an accelerometer. In some embodiments, the sensor is an acoustic sensor. In some embodiments, the sensor is a force sensor. In some embodiments, the force sensor comprises a load cell.

In some embodiments, the apparatus further comprises a second sensor that is a vibration sensor, a gyroscope, a magnetometer, a temperature sensor, a humidity sensor, a particulate sensor, a sensor of electromagnetic radiation, an atmospheric pressure sensor, a solar energy incidence sensor, a solar flux sensor, a wind speed sensor, a proximity sensor, or an image sensor.

In some embodiments, the detection plate has an area of at least 3.5 square feet to approximately 100 square feet or more (e.g., approximately 3, 4, 5, 6, 7, 8, 9, 10, 15, 20, 25, 30, 35, 40, 45, 50, 55, 60, 70, 75, 80, 85, 90, 95, or 100 square feet or more).

In some embodiments, the apparatus further comprises a microprocessor. In some embodiments, the microprocessor is configured to receive inputs from said sensor. In some embodiments, the microprocessor is configured to calculate hydrometeor impact data. In some embodiments, the microprocessor is configured to receive inputs from a plurality of sensors (e.g., a plurality of sensors for detecting hydrometeor impacts; in some embodiments, a sensor for detecting hydrometeor impacts and at least one other type of sensor). In some embodiments, the microprocessor is configured to calculate hydrometeor impact data from multiple sensor signals. In some embodiments, the microprocessor is configured to calculate hydrometeor impact data comprising hydrometeor size, hydrometeor volume, hydrometeor mass, hydrometeor momentum, hydrometeor energy, hydrometeor peak stress (e.g., peak force and/or peak acceleration), and/or hydrometeor velocity. In some embodiments, the microprocessor is configured to calculate a distribution, range, mean, mode, and/or median of one or more of hydrometeor impact data comprising hydrometeor size, hydrometeor volume, hydrometeor mass, hydrometeor momentum, hydrometeor energy, hydrometeor peak stress (e.g., peak force and/or peak acceleration), and/or hydrometeor velocity for a plurality of hydrometeors.

In some embodiments, the apparatus further comprises a supporting frame. In some embodiments, the apparatus further comprises a force sensor between said supporting frame and said detection plate. In some embodiments, the apparatus further comprises a plurality of force sensors between said supporting frame and said detection plate.

In some embodiments, the apparatus further comprises a global navigation satellite system receiver, a wireless communications radio, and/or an antenna.

Furthermore, in some embodiments the apparatus comprises a sensor that is provided in a sensor pack. In some embodiments, the technology provides an apparatus comprising a detection plate and a sensor pack affixed to the underside of said detection plate. In some embodiments, the sensor pack comprises a plurality of sensors. In some embodiments, the sensor pack comprises a weatherized enclosure (e.g., to provide protection to the sensors and/or other components that are inside the weatherized enclosure of the sensor pack). In some embodiments, the sensor pack comprises an accelerometer. In some embodiments, the sensor pack comprises an acoustic sensor. In some embodiments, the sensor pack comprises a component for data transmission (e.g., a wireless communications component (e.g., a Dedicated Short Range Communications (DSRC), GPS, cellular (e.g., 4G, 5G), BLUETOOTH, LORA, Sigfox, LPWAN, and/or WiFi (e.g., (IEEE 802.11 (e.g., Wi-Fi 4, 5, 6, etc. standard))) radio). In some embodiments, the sensor pack comprises a component for receiving a data transmission (e.g., a Dedicated Short Range Communications (DSRC), GPS, cellular (e.g., 4G, 5G), BLUETOOTH, LORA, Sigfox, LPWAN, and/or WiFi (e.g., (IEEE 802.11 (e.g., Wi-Fi 4, 5, 6, etc. standard))) radio). In some embodiments, the sensor pack comprises a component for data storage. In some embodiments, the sensor pack comprises a microprocessor. In some embodiments, the sensor pack comprises output connectors and/or input connectors.

In some embodiments, the apparatus comprising a sensor pack further comprises an elastic covering component. In some embodiments, the elastic covering component partially covers the top of the detection plate. In some embodiments, the elastic covering component fully covers the top of the detection plate. In some embodiments, the elastic covering component comprises a rubber, foam, membrane, meshed material, or net. In some embodiments, the elastic covering component permits transmission of sunlight. In some embodiments, the elastic covering component permits transmission of electromagnetic radiation having a wavelength greater than approximately 1100 nm. (e.g., greater than approximately 1000, 1050, 1100, 1150, 1200, 1250, 1300 nm or more). In some embodiments, the elastic covering component permits transmission of light sufficient to produce electric current by a photovoltaic panel. In some embodiments, the elastic covering component transmits approximately 20, 25, 30, 35, 40, 45, 50, 55, 60, 65, 70, 75, 80, 85, 90, 95, or 100% of the electromagnetic radiation contacting it. In some embodiments, the elastic covering component transmits approximately 20, 25, 30, 35, 40, 45, 50, 55, 60, 65, 70, 75, 80, 85, 90, 95, or 100% of a selected wavelength or range of wavelengths of electromagnetic radiation contacting it. In some embodiments, the elastic covering component comprises silicone. In some embodiments, the detection plate comprises a solar panel. In some embodiments, the detection plate has an area of at least 1 square foot to approximately 100 square feet or more (e.g., approximately 1, 2, 3, 4, 5, 6, 7, 8, 9, 10, 15, 20, 25, 30, 35, 40, 45, 50, 55, 60, 70, 75, 80, 85, 90, 95, or 100 square feet or more). In some embodiments, the microprocessor is configured to receive inputs from a sensor. In some embodiments, the microprocessor is configured to receive inputs from a plurality of sensors. In some embodiments, the microprocessor is configured to calculate hydrometeor impact data. In some embodiments, the microprocessor is configured to calculate hydrometeor impact data from a plurality of sensor signals. In some embodiments, the apparatus comprising a sensor pack further comprises a supporting frame. In some embodiments, the apparatus further comprises a force sensor between said supporting frame and said detection plate.

In some embodiments, the technology provides a kit comprising a detection plate and a sensor. In some embodiments, the technology provides a kit comprising a detection plate and a sensor pack. In some embodiments, the kits further comprise an elastic covering component. In some embodiments, kits comprise a sensor or a sensor pack and an adhesive. In some embodiments, the adhesive comprises caulk or silicone. In some embodiments, the technology provides a kit comprising a sensor or a sensor pack and an elastic covering component. In some embodiments, a kit further comprises a composition for affixing the sensor or sensor pack to a detection plate. In some embodiments, the composition comprises an adhesive. In some embodiments, the kit further comprises a support frame and a force sensor.

In some embodiments, the technology provides a system comprising an apparatus as described herein. In some embodiments, the systems further comprise a computer. In some embodiments, systems further comprise a software component configured to receive as inputs impact data and characterize impacts. In some embodiments, systems comprise two or more said apparatuses. In some embodiments of systems, two or more said apparatuses distributed over a geographic region and in communication with a computer. In some embodiments, an apparatus as described herein and a computer are housed in a single unit. In some embodiments, an apparatus as described herein and a computer are connected by a network. In some embodiments, a system comprises two or more apparatuses distributed over a region having an area of 100 to 100,000 m². In some embodiments, a system comprises two or more apparatuses separated from one another by 10 to 10,000 m.

In some embodiments, the technology provides a method of detecting an impactor, e.g., a hydrometeor, e.g., a hail stone. In some embodiments, methods comprise providing an apparatus as described herein; and recording a signal produced by an impact on said detection plate. As used herein, “providing an apparatus” as described herein refers to assembling an apparatus as described herein, obtaining an apparatus as described herein, ordering an apparatus as described herein, and/or having made an apparatus as described herein. In some embodiments, “providing an apparatus” as described herein comprises providing one or more components of the apparatus, all of the component of the apparatus, and/or providing some of the components of the apparatus for use with a component provided by another actor.

In some embodiments, methods further comprise calculating impact data from said signal. In some embodiments, methods further comprise performing frequency analysis on said signal. In some embodiments, methods further comprise transmitting said signal. In some embodiments, methods further comprise transmitting said impact data. In some embodiments, methods further comprise receiving said signal. In some embodiments, methods further comprise calibrating said apparatus.

In some embodiments, providing an apparatus comprises affixing a sensor to a previously installed detection plate. In some embodiments, the detection plate comprises a solar panel. In some embodiments, providing an apparatus comprises affixing a sensor pack to a previously installed detection plate. In some embodiments, providing an apparatus comprises covering the top of the detection plate with an elastic covering component. In some embodiments, methods further comprise identifying a previously installed detection plate (e.g., a solar panel, shingle, HVAC system component, etc.) In some embodiments, methods further comprise accessing a previously installed detection plate.

In some embodiments, methods further comprise receiving a signal from one or more of a vibration sensor, a gyroscope, a magnetometer, a temperature sensor, a humidity sensor, a particulate sensor, a sensor of electromagnetic radiation, an atmospheric pressure sensor, a solar energy incidence sensor, a solar flux sensor, a wind speed sensor, a proximity sensor, or an image sensor. In some embodiments, methods comprise calculating hydrometeor impact data from multiple sensor signals. In some embodiments, methods comprise calculating hydrometeor impact data comprising hydrometeor size, hydrometeor volume, hydrometeor mass, hydrometeor momentum, hydrometeor energy, hydrometeor peak stress (e.g., peak force and/or peak acceleration), and/or hydrometeor velocity. In some embodiments, methods comprise calculating a distribution, range, mean, mode, and/or median of one or more of hydrometeor impact data comprising hydrometeor size, hydrometeor volume, hydrometeor mass, hydrometeor momentum, hydrometeor energy, hydrometeor peak stress (e.g., peak force and/or peak acceleration), and/or hydrometeor velocity for a plurality of hydrometeors.

The technology finds use in a range of applications. For example, in some embodiments, the technology provides use of an apparatus as described herein to detect a hydrometeor. In some embodiments, the technology provides use of an apparatus as described herein to detect a hydrometeor. In some embodiments, the technology provides use of a method as described herein to detect a hydrometeor. In some embodiments, the technology provides use of a kit to assemble an apparatus as described herein, e.g., to assemble an apparatus as described herein in the field, to assemble an apparatus as described herein comprising one or more components (e.g., a detection plate (e.g., a solar panel)) provided by another user and/or having been previously installed. In some embodiments, the technology provides use of a system as described herein to detect a hydrometeor. Additional embodiments will be apparent to persons skilled in the relevant art based on the teachings contained herein.

The present technology provides several advantages relative to conventional technologies. For example, embodiments provide affixing components to existing solar panels in the field to provide the hail sensing apparatus. Further, the apparatus is powered by the solar panels in some embodiments. Thus, in some embodiments, apparatuses do not require an external power source. Embodiments of the present technology are not hindered by attachment considerations, e.g., related to the quality of adhesives, temperature dependency, stringent surface prep, and manufacturing variability of assembly, that affect conventional technologies such as those comprising a contact (e.g., piezoelectric) sensor of physical motion. Embodiments provide a network comprising multiple apparatuses in a networked wherein a plurality of apparatuses transmit simultaneously. Such a network of apparatuses provide “blanket” coverage of storms and thus reduce and/or eliminate chasing storms to record data.

In some embodiments, the technology provides an apparatus for measuring the peak stress of a hail impact. For example, in some embodiments, the technology provides an apparatus comprising a detection plate; a sensor configured to sense acceleration of said detection plate and produce a signal (e.g., an accelerometer, an acoustic sensor, and/or a load cell); an analog-to-digital converter configured to sample said signal at an ultra-high frequency; and a microprocessor configured to identify a peak of said signal as a hail impact and measure the peak stress of said hail impact. In some embodiments, the ultra-high frequency is greater than 100 kHz (e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)). In some embodiments, the detection plate comprises a solar panel. In some embodiments, a sensor pack comprises said sensor. In some embodiments, the sensor pack is affixed to the underside of said detection plate. In some embodiments, the sensor pack comprises a weatherized enclosure, a component for data transmission, a component for data storage, a microprocessor, output connectors, and/or input connectors. In some embodiments, the microprocessor is configured to calculate hail impact data comprising hail size, hail volume, hail mass, hail momentum, hail energy, hail impact force, hail velocity, and/or hail damage. In some embodiments, the microprocessor is configured to calculate a distribution, range, mean, mode, and/or median of one or more of hail impact data comprising hail size, hail volume, hail mass, hail momentum, hail energy, hail impact force, hail velocity, and/or hail damage. In some embodiments, the apparatus further comprises a supporting frame and wherein said sensor is between said supporting frame and said detection plate. In some embodiments, the apparatus further comprises a global navigation satellite system receiver, a wireless communications radio, and/or an antenna. In some embodiments, the apparatus comprises a second sensor (e.g., an accelerometer, an acoustic sensor, a load cell, a vibration sensor, a gyroscope, a magnetometer, a temperature sensor, a humidity sensor, a particulate sensor, a sensor of electromagnetic radiation, at atmospheric pressure sensor, a solar energy incidence sensor, a solar flux sensor, a wind speed sensor, a proximity sensor, and/or an image sensor). In some embodiments, the detection plate has an area of at least 3.5 square feet to 100 square feet. In some embodiments the microprocessor is configured to receive inputs from said sensor. In some embodiments, the microprocessor is configured to receive inputs from a plurality of sensors. In some embodiments, the microprocessor is configured to calculate the peak stress of a hail impact from multiple sensor signals. In some embodiments, the technology provides use of an apparatus as described herein to detect a hail impact.

In related embodiments, the technology provides a kit for measuring the peak stress of a hail impact. For example, in some embodiments, the kit comprises a sensor configured to be affixed to a detection plate (e.g., an accelerometer, an acoustic sensor, and/or a load cell), to sense acceleration of said detection plate, and to produce a signal; an analog-to-digital converter configured to sample said signal at an ultra-high frequency; and a microprocessor configured to identify a peak of said signal as a hail impact and measure the peak stress of said hail impact. In some embodiments, the ultra-high frequency is greater than 100 kHz ((e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)). In some embodiments, the sensor is configured to be affixed to a solar panel. In some embodiments, the kit further comprises an adhesive. In some embodiments, the sensor is provided in a sensor pack. In some embodiments, the kit further comprises a supporting frame. In some embodiments, the sensor pack comprises a weatherized enclosure, a component for data transmission, a component for data storage, a microprocessor, output connectors, and/or input connectors. In some embodiments, the microprocessor is configured to calculate hail impact data comprising hail size, hail volume, hail mass, hail momentum, hail energy, hail impact force, hail velocity, and/or hail damage. In some embodiments, the microprocessor is configured to calculate a distribution, range, mean, mode, and/or median of one or more of hail impact data comprising hail size, hail volume, hail mass, hail momentum, hail energy, hail impact force, hail velocity, and/or hail damage. In some embodiments, the kit further comprises a global navigation satellite system receiver, a wireless communications radio, and/or an antenna. In some embodiments, the kit comprises a second sensor (e.g., an accelerometer, an acoustic sensor, a load cell, a vibration sensor, a gyroscope, a magnetometer, a temperature sensor, a humidity sensor, a particulate sensor, a sensor of electromagnetic radiation, at atmospheric pressure sensor, a solar energy incidence sensor, a solar flux sensor, a wind speed sensor, a proximity sensor, and/or an image sensor). In some embodiments, the microprocessor is configured to receive inputs from the sensor. In some embodiments, the microprocessor is configured to receive inputs from a plurality of sensors. In some embodiments, the microprocessor is configured to calculate the peak stress of a hail impact from multiple sensor signals. In some embodiments, the technology provides use of a kit as described herein to assemble a hail detection apparatus in the field.

In some embodiments, the technology provides a system. In some embodiments, the system comprises an apparatus as described herein (e.g., an apparatus for measuring the peak stress of a hail impact (e.g., an apparatus comprising a detection plate; a sensor configured to sense acceleration of said detection plate and produce a signal (e.g., an accelerometer, an acoustic sensor, and/or a load cell); an analog-to-digital converter configured to sample said signal at an ultra-high frequency; and a microprocessor configured to identify a peak of said signal as a hail impact and measure the peak stress of said hail impact)). In some embodiments, the system further comprises a computer. In some embodiments, the system further comprises a software component configured to receive as inputs hail impact data and characterize hail impacts. In some embodiments, the impact data comprises peak stress data. In some embodiments, systems comprise two or more apparatuses as described herein (e.g., at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 apparatuses). In some embodiments, the two or more said apparatuses are distributed over a geographic region and in communication with a computer. In some embodiments, the two or more apparatuses are distributed over a region having an area of 100 to 100,000 m². In some embodiments, the two or more apparatuses are separated from one another by 10 to 10,000 m. In some embodiments, an apparatus and a computer are housed in a single unit. In some embodiments, an apparatus and a computer are connected by a network. In some embodiments, the technology provides use of a system as described herein to detect a hail impact.

Some embodiments provide a method of measuring the peak stress of a hail impact. In some embodiments, methods comprise providing an apparatus as described herein (e.g., an apparatus for measuring the peak stress of a hail impact (e.g., an apparatus comprising a detection plate; a sensor configured to sense acceleration of said detection plate and produce a signal (e.g., an accelerometer, an acoustic sensor, and/or a load cell); an analog-to-digital converter configured to sample said signal at an ultra-high frequency; and a microprocessor configured to identify a peak of said signal as a hail impact and measure the peak stress of said hail impact)); obtaining a signal produced by said sensor; sampling said signal at an ultra-high frequency; identifying a peak of said signal to identify a hail impact; and measuring the peak stress of said hail impact. In some embodiments, ultra-high frequency is greater than 100 kHz ((e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)). In some embodiments, methods further comprise calculating hail impact data from the signal. In some embodiments, hail impact data comprises hail size, hail volume, hail mass, hail momentum, hail energy, hail impact force, hail velocity, and/or hail damage. In some embodiments, methods further comprise calculating a distribution, range, mean, mode, and/or median of one or more of hail impact data comprising hail size, hail volume, hail mass, hail momentum, hail energy, hail impact force, hail velocity, and/or hail damage. In some embodiments, methods further comprise receiving inputs from the sensor by the microprocessor. In some embodiments, methods further comprise calculating the peak stress of a hail impact from multiple sensor signals. In some embodiments, methods further comprise performing frequency analysis on the signal. In some embodiments, methods further comprise transmitting the signal. In some embodiments, methods comprise buffering the signal and sending the peak stress of the hail impact when a hail impact is detected. In some embodiments, methods further comprise transmitting said hail impact data. In some embodiments, methods comprise calibrating the apparatus.

In some embodiments, the providing step of the method comprises affixing a sensor to a previously installed detection plate. In some embodiments, the detection plate comprises a solar panel. In some embodiments, the providing step comprises affixing a sensor pack to a previously installed detection plate. In some embodiments, methods comprise identifying a previously installed detection plate. In some embodiments, methods comprise accessing a previously installed detection plate.

In some embodiments, methods further comprise receiving a signal from one or more of a vibration sensor, a gyroscope, a magnetometer, a temperature sensor, a humidity sensor, a particulate sensor, a sensor of electromagnetic radiation, an atmospheric pressure sensor, a solar energy incidence sensor, a solar flux sensor, a wind speed sensor, a proximity sensor, or an image sensor. In some embodiments, methods comprise calculating hydrometeor impact data from multiple sensor signals. In some embodiments, methods further comprise calculating hydrometeor impact data comprising hydrometeor size, hydrometeor volume, hydrometeor mass, hydrometeor momentum, hydrometeor energy, and/or hydrometeor velocity. In some embodiments, methods comprise calculating a distribution, range, mean, mode, and/or median of one or more of hydrometeor impact data comprising hydrometeor size, hydrometeor volume, hydrometeor mass, hydrometeor momentum, hydrometeor energy, and/or hydrometeor velocity for a plurality of hydrometeors. Some embodiments of the technology provide use of a method as described herein to detect a hail impact.

### BRIEF DESCRIPTION OF THE DRAWINGS

These and other features, aspects, and advantages of the present technology will become better understood with regard to the following drawings:

FIG. 1 is a drawing of an embodiment of the technology provided herein comprising a solar panel and a sensor package. Features of embodiments of the technology shown in FIG. 1 include, e.g., a solar (e.g., photovoltaic) panel 1; a sensor package 2; a junction box 3 (e.g., electrically connected to the solar panel); input connectors 4 into the sensor package; and output connectors 5 from the sensor package.

FIG. 2 is a drawing in profile view of an embodiment of the technology provided herein comprising an elastic covering. Features of embodiments of the technology shown in FIG. 2 include, e.g., a solar (e.g., photovoltaic) panel 1; a sensor package 2; and an elastic covering component 6.

FIG. 3 is a drawing of an embodiment of the technology provided herein comprising a solar panel and multiple sensor packages. Features of embodiments of the technology shown in FIG. 3 include, e.g., a solar (e.g., photovoltaic) panel 1; a sensor package 2; and one or more additional sensors 7 (e.g., vibration sensor, acoustic sensor (e.g., MEMs microphone, electret microphone, piezoelectric transducer), accelerometer, global positioning satellite receiver, magnetometer, gyroscope, etc.)

FIG. 4 is a drawing of an embodiment of the technology provided herein comprising load cell sensors to measure forces on the detection plate. Features of embodiments of the technology shown in FIG. 4 include, e.g., a solar (e.g., photovoltaic) panel 1; a sensor package 2; and one or more “feet” comprising a load cell (e.g., for direct measurement of forces acting on the detection plate). In some embodiments, one or more “feet” comprising a load cell is/are connected to a sensor pack as described herein.

FIG. 5 is a plot 6 showing the force on a detection plate (measured as a voltage output by the sensor) as a function of time for a hydrometeor impact event detected by hydrometeor sensor as described herein. The vertical axis shows values of approximately 0 V (bottom) to 3 V (top); the horizontal axis shows an elapsed time of approximately 0.15 seconds.

FIG. 6 is a plot showing the frequency-energy spectrum (e.g., showing an energy signature) 7 for a hydrometeor impact event detected by hydrometeor sensor as described herein. The vertical axis shows values of approximately −20 (bottom) to 160 (top); the horizontal axis shows values of approximately 0 (left) to 400 (right). In FIG. 7, the solid line shows the signal produced by an impact and the dotted line shows the signal in the absence of an impact.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Provided herein is technology relating to measuring and recording weather phenomena and particularly, but not exclusively, to apparatuses, methods, kits, and systems for measuring hydrometeor impacts, e.g., hail impacts.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, the terms “about”, “approximately”, “substantially”, and “significantly” are understood by persons of ordinary skill in the art and will vary to some extent on the context in which they are used. If there are uses of these terms that are not clear to persons of ordinary skill in the art given the context in which they are used, “about” and “approximately” mean plus or minus less than or equal to 10% of the particular term and “substantially” and “significantly” mean plus or minus greater than 10% of the particular term.

As used herein, the suffix “-free” refers to an embodiment of the technology that omits the feature of the base root of the word to which “-free” is appended. That is, the term “X-free” as used herein means “without X”, where X is a feature of the technology omitted in the “X-free” technology. For example, a “calcium-free” composition does not comprise calcium, a “mixing-free” method does not comprise a mixing step, etc.

As used herein, an “impactor” refers to an entity that impacts an apparatus as described herein, e.g., a hydrometeor (e.g., a hail stone). An impactor may be natural or artificially produced, e.g., an impactor includes ice produced in a laboratory having defined characteristics (e.g., size, solid/liquid ratio, volume, mass, temperature, etc.) In some embodiments, an impactor has defined characteristics and comprises a material that is not ice, e.g., a wood, plastic, and/or metal ball. In some embodiments, an impactor (natural or artificial) is used to test an apparatus as described herein.

As used herein “impact data”, “hydrometeor data” (e.g., “hail stone data”), and the like comprise one or more of hydrometeor size (e.g., hydrometeor dimensions (e.g., diameter, radius)), hydrometeor mass, peak stress (e.g., peak acceleration and/or peak force), and/or hydrometeor volume. In some embodiments, hydrometeor data are related to a moving hydrometeor, a force with which a hydrometeor impacts a surface (e.g., a detection plate), and/or an acceleration of a hydrometeor (and/or acceleration of a detection plate caused by a hydrometeor impact). In some embodiments, hydrometeor data comprises the peak stress (e.g., peak force and/or peak acceleration) of the hydrometeor at impact, e.g., a force with which a hydrometeor impacts a surface (e.g., a detection plate) and/or the acceleration of a detection plate caused by a hydrometeor impact at the time of peak stress of a hydrometeor. For example, in some embodiments, hydrometeor data comprise hydrometeor momentum, hydrometeor velocity, hydrometeor direction, hydrometer acceleration, hydrometeor energy, hydrometeor peak stress (e.g., peak force and/or peak acceleration), and/or hydrometeor speed. In some embodiments, hydrometeor data comprise a position of impact of a hydrometeor on a detection plate. In some embodiments, hydrometeor data comprise a location on the earth (e.g., provided as latitude and longitude coordinates and/or as GPS coordinates) where an apparatus impacted by a hydrometeor is located. In some embodiments, hydrometeor data are expressed as a vector comprising one, two, three, four, or more dimensions. In some embodiments, hydrometeor data comprise data describing a plurality of hydrometeors, e.g., a distribution, mean, mode, or other statistical treatment and/or description of any of the aforementioned properties and/or characteristics measured for a plurality of hydrometeors.

As used herein, the term “characterizing a hydrometeor” (e.g., a hail stone) refers to measuring, recording, quantifying, and/or describing qualitatively one or more characteristics of a hydrometeor, e.g., measuring, recording, quantifying, and/or describing qualitatively one or more types of “impact data”, “hydrometeor data” (e.g., “hail stone data”), and the like.

As used herein, a “large hail stone” is hail stone having a sufficient diameter to provide a hail stone mass that damages common materials. A hail stone (e.g., an idealized spherical hailstone of nominal terminal velocity, density, and hardness) of approximately greater than 1.0 to 1.5 inches produces visible damage to common materials. Accordingly, as used herein, the term “large hail stone” refers in some embodiments to a hail stone having a diameter of approximately 1 inch or more (e.g., a diameter greater than 1.0, 1.1, 1.2, 1.3, 1.4, or 1.5 inches or more). Further, the term “large hail” refers to a plurality of hail stones having a distribution of diameters in which at least 50% of the hail stones are large hail stones.

As used herein, the “top” of the detection panel refers to the surface of the detection panel facing the sky that is impacted by hydrometeors (e.g., hail). As used herein, the “underside” of the detection panel refers to the surface of the detection panel opposite the top side of the detection panel.

As used herein, the term “global positioning system” and “GPS” refers to any global navigation satellite system including the GPS system of satellites and related technologies (e.g., GPS radios) and other similar systems including but not limited to GLONASS (Russia), Galileo (EU), NAVIC (India), QZSS (Japan), and BeiDou (China).

As used herein, the term “hydrometeor” refers to atmospheric aqueous precipitation in its various forms, including but not limited to rain, hail, sleet, snow, and freezing rain.

As used herein, the term “amount of precipitation” or “accumulation of precipitation” refers to the vertical depth on a flat surface of the amount of water precipitated.

As used herein, the term “intensity of precipitation” or, in some embodiments, “rain rate” or “hail rate” refers to the accumulation of precipitation per unit of time.

As used herein, the term “hail-size distribution” refers to the number of hail stones of defined, discreet sizes or in defined, discreet ranges of sizes.

### Apparatus

In some embodiments, the technology provides an apparatus for detecting hydrometeor impacts (e.g., hail). In some embodiments, the apparatus comprises a detection plate and a sensor (e.g., provided in a sensor pack). In some embodiments, the apparatus comprises an analog-to-digital converter (e.g., an analog-to-digital converter capable of sampling signals output by the hail detection plate and/or one or more sensors connected to the hail detection plate at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)). In some embodiments, the apparatus comprises an elastic covering component, e.g., covering at least a portion of the top of the detection plate.

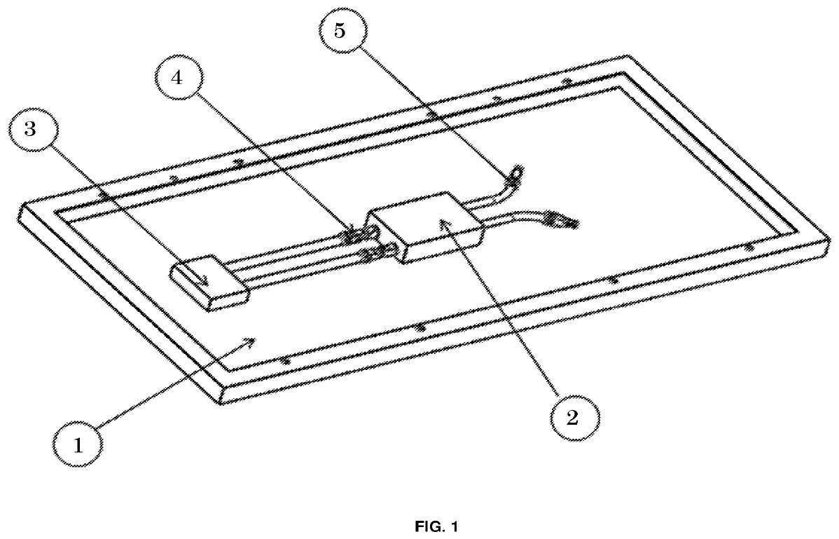

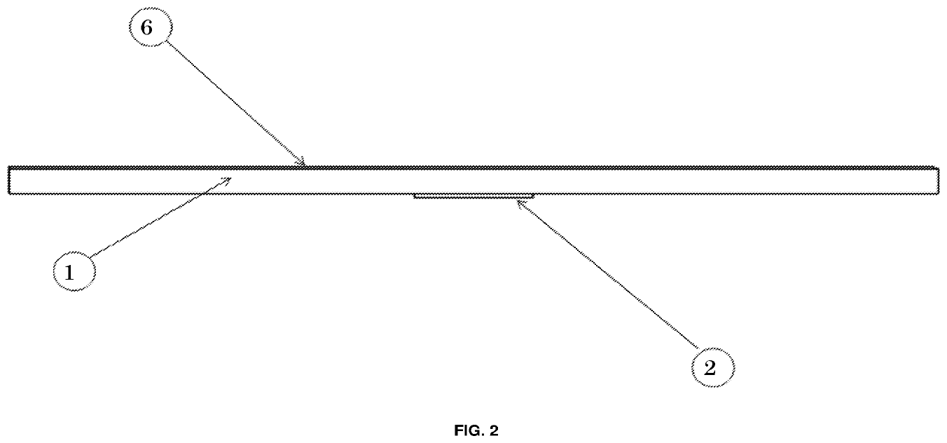

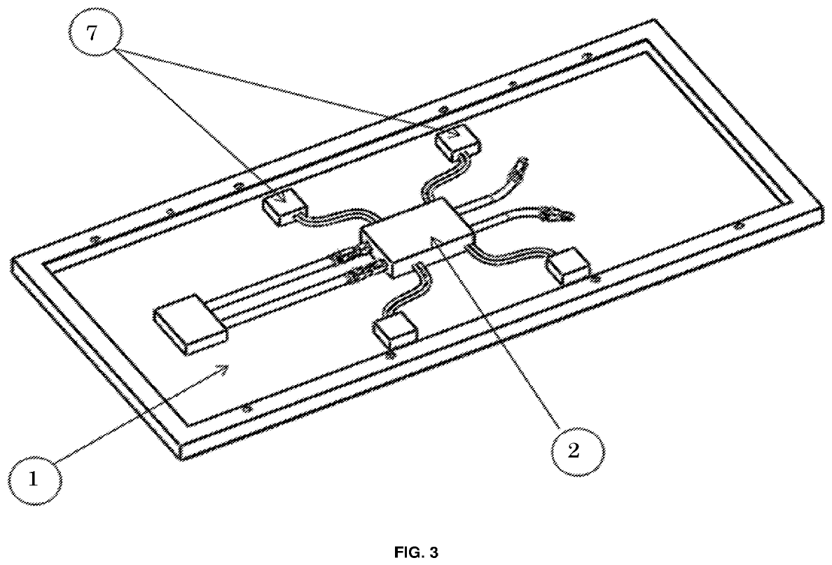

In some embodiments, e.g., as shown in FIG. 1, the technology provides an apparatus comprising a detection plate (e.g., a solar panel (e.g., photovoltaic panel)) 1 and a sensor package 2. In some embodiments, the apparatus further comprises one or more of a junction box 3 (e.g., electrically connected to the solar panel); input connectors 4 into the sensor package; and/or output connectors 5 from the sensor package. In some embodiments, e.g., as shown in FIG. 2, the technology provides an apparatus further comprising an elastic covering 6. In some embodiments, e.g., as shown in FIG. 3, technology provides an apparatus comprising a detection plate (e.g., a solar panel (e.g., photovoltaic panel)) 1; a sensor package 2; and one or more additional sensors 7 (e.g., a vibration sensor, an acoustic sensor (e.g., a MEMS microphone, an electret microphone, a piezoelectric transducer), an accelerometer, a global positioning satellite receiver, a light sensor, a magnetometer, a gyroscope, an altimeter (e.g., a barometric pressure sensor), etc.) In some embodiments, the apparatus comprises an analog-to-digital converter (e.g., an analog-to-digital converter capable of sampling signals output by the hail detection plate and/or one or more sensors connected to the hail detection plate at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)).

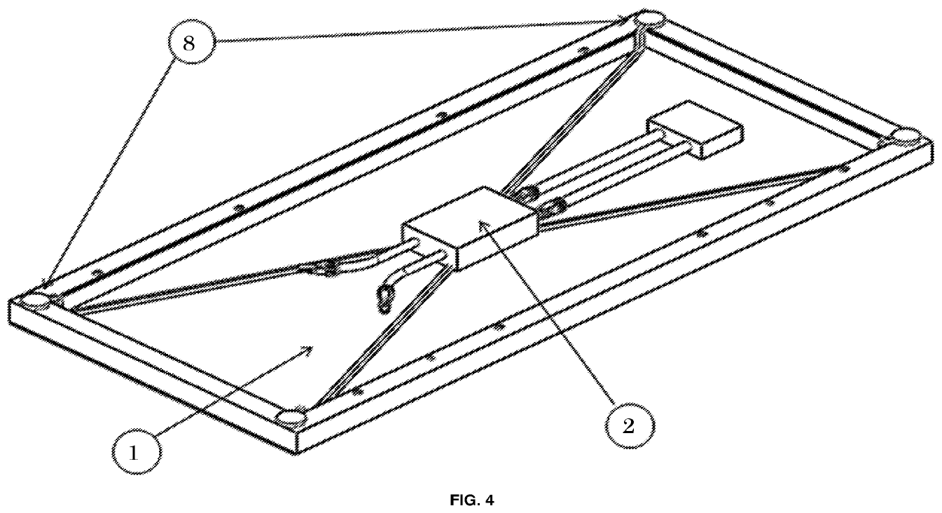

In some embodiments, e.g., as shown in FIG. 4, the technology provides an apparatus comprising one or more load cell sensors to measure forces on the detection plate, e.g., one or more “feet” comprising a load cell (e.g., for direct measurement of forces acting on the detection plate). Load cells are widely used off-the-shelf components and are available commercially (e.g., from HBM, Inc., Marlborough, Mass.). In some embodiments, a load cell comprises one or more strain gages. In some embodiments, a load cell is protected from the environment (e.g., to prevent exposure to cold, water, sun, dust, etc.). Accordingly, in some embodiments, a load cell is protected with a protective weatherized coating.

FIG. 1 pictures an embodiment in which the device comprises a sensor pack 2 affixed to a detection plate 1. In some embodiments, the sensor pack comprises sensors to detect the acoustic power produced by impacts on the detection plate. In some embodiments, the sensor pack comprises sensors to detect strain produced in the detection plate, angular velocity of the detection plate (e.g., changes in angular velocity of the detection plate), and/or acceleration of the detection plate. In some embodiments, the sensor pack comprises sensors to detect any combination of the aforementioned. In some embodiments, signals produced by the sensors are used to detect impacts of hydrometeors, including hailstones and grauple, on the detection plate. In some embodiments, the device (e.g., a sensor pack of a device) comprises an analog-to-digital converter (e.g., an analog-to-digital converter capable of sampling signals output by the hail detection plate and/or one or more sensors connected to the hail detection plate at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)). In some embodiments, wiring from a solar panel exits from the junction box 3 and enters the sensor pack 2 through mating connectors that are part of the sensor pack housing. In some embodiments, similar cables comprising mating connectors 5 exit the sensor package housing to connect to the intended downstream application. In some embodiments, the sensor pack comprises internal electronics that are powered by residual power leeched off of the solar panel with battery storage for times of low-light. In some embodiments comprising load cell sensors (e.g., FIG. 4), the load cell sensors are connected (e.g., by one or more wires) to a sensor pack.

The technology is not limited in the material used for the detection panel, e.g., provided that the material is able to withstand impacts of hail stones striking the apparatus. In some embodiments, the detection panel is a rigid panel. In some embodiments, the detection panel is a semi-rigid panel. In some embodiments, the detection panel comprises a material that is a metal, a polymer (e.g., plastic), or comprises another organic (e.g., carbon fiber) or inorganic (e.g., silicon) material. In some embodiments, the detection plate comprises and/or is a solar panel (e.g., photovoltaic panel). In some embodiments, a solar panel used as a detection plate is field fitted with the sensor package. In some embodiments, the detection panel comprises a grid or mosaic array of small solid-state force sensors or a pressure sensitive screen, e.g., to measure the force and position of a hailstone strike on short (e.g., nanosecond, microsecond, or millisecond) timescales (e.g., peak hailstone force and/or peak hailstone acceleration), e.g., by sampling at a sufficiently high rate (e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)) to provide peak stress (e.g., peak force and/or peak acceleration) measurements of force and/or acceleration.

In some embodiments, detecting large hail stones and/or the most damaging hail stones for a given location is important because large hail stones and/or the most damaging hail stones are directly correlated with damage (e.g., to property, crops, etc.). During the development of embodiments of the technology described herein, experiments were conducted to detect impacts of hail having a size distribution the same or similar to the size distribution of hail in a natural hail storm. In particular, data were collected to detect impacts of hail from a natural hail storm. Data collected during these experiments indicated that the impact frequency of large (e.g., and thus most damaging) hail stones and/or the spatial distribution of large hail stones was insufficient to produce a reliable hail impact record on a detection surface of approximately 1.5 feet×2.5 feet (e.g., having a surface area of approximately 3.75 square feet). The hail impacts recorded by an apparatus comprising a detection surface of approximately 1.5 feet×2.5 feet (e.g., having a surface area of approximately 3.75 square feet) were thus not adequate for analysis, e.g., to determine forces and/or estimate damage caused by impacting hail, in particular for large hail stones. That is, large hail stones did not impact a detection surface of 1.5 feet×2.5 feet (e.g., having a surface area of 3.75 square feet) enough times and thus did not provide adequate data for an analysis of hail size distribution, momentum, velocity, and/or force. Accordingly, in some embodiments, the top surface of the detection panel has an area of more than approximately 3.5 square feet, e.g., to provide a sufficiently large surface to record a sufficient number of impacts by large hail stones. In some embodiments, the top surface of the detection panel has an area of approximately 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0 square feet. In some embodiments, the top surface of the detection panel is circular, oval, polygonal (e.g., quadrilateral (e.g., square, rectangular, trapezoid, rhomboid)), or an irregular shape.

However, in some cases, deploying a hydrometeor sensing apparatus comprising a detection plate having a surface area of 3.5 or more square feet is associated with a high cost of production, high cost of installation, and/or increased difficulty to transport and/or install a hydrometeor sensing apparatus comprising a detection plate having a surface area of 3.5 or more square feet in locations that are difficult to access and/or locations to which transport of materials is difficult. Thus, in some embodiments, the technology comprises an apparatus comprising a detection plate that has been previously installed. In particular, in some embodiments, the sensor and/or a sensor package (e.g., comprising one or more sensors and, optionally, associated electronic components) is mounted directly to the underside of a detection plate already on site (e.g., a solar panel). In some embodiments, an elastic cover component is installed on a detection plate that is already on site (e.g., a solar panel). Embodiments of the technology provide kits comprising components (e.g., a sensor package and/or an elastic covering component) for attaching to a detection plate (e.g., a solar panel) in the field (e.g., a previously installed solar panel). Embodiments of the technology also provide systems comprising components (e.g., a sensor package and/or an elastic covering component) attached to a detection plate (e.g., a solar panel) in the field (e.g., a previously installed solar panel). Kit and system embodiments are described herein.

In some embodiments, the apparatus comprises a sensor to detect hydrometeors impacting the detection plate. In some embodiments, the sensor is a vibration sensor, a load cell, a strain gauge, an acoustic sensor (e.g., a MEMS microphone, an electret microphone, a piezoelectric transducer), an accelerometer, a global positioning satellite (GPS) receiver, a magnetometer, or a gyroscope. In some embodiments, the apparatus comprises sensors to measure temperature, atmospheric pressure, humidity, and/or solar energy incidence and/or solar energy flux. In some embodiments, the apparatus comprises a wind speed sensor. In some embodiments, the apparatus comprises a proximity sensor.

In some embodiments, the apparatus comprises multiple sensors and/or multiple sensor types and/or multiple sensors of multiple sensor types. In some embodiments, the apparatus comprises one or more of an accelerometer, a load cell, and/or a strain gauge to determine the size and/or momentum of a hydrometeor impacting the detection plate. In some embodiments, the apparatus comprises one or more accelerometers. In some embodiments, the apparatus comprises one or more strain gauges. In some embodiments, the apparatus comprises one or more load cells. In some embodiments, the apparatus further comprises one or more gyroscopes to sense the angular rotation of the flexure of the detection plate caused by a hydrometeor impact. In some embodiments, the apparatus comprises one or more acoustic sensors to measure the acoustic force and/or acoustic energy produced by a hydrometeor impacting the detection plate.

In some embodiments, the sensor is an acoustic sensor. In some embodiments, the acoustic sensor is a transducer that converts sound into an electrical signal. In some embodiments, the acoustic sensor comprises a microphone. The technology is not limited in the type of microphone that is used. For example, in some embodiments, the microphone is an electret microphone. In some embodiments, the microphone is a condenser microphone. In some embodiments, the technology comprises use of an electret microphone that does not require phantom power. Accordingly, in some embodiments, the technology does not comprise a condenser microphone (e.g., a microphone that requires phantom power) and is thus, in some embodiments, a “condenser microphone-free” apparatus. In some embodiments, the microphone is a piezoelectric microphone. In piezoelectric microphone embodiments, the piezoelectric element does not detect impacts of a surface directly (e.g., by attachment to the impacted surface (e.g., the piezoelectric element is not mechanically and/or physically attached to the impacted surface)), but instead the piezoelectric element detects acoustic signals produced by impacts on the contacted surface (e.g., the detection plate) by detecting the acoustic pressure changes caused by impacts on the contacted surface. That is, an air gap separates the contacted surface and the piezoelectric element and the air conducts an acoustic signal from the contacted surface to the piezoelectric element.

In some embodiments, the microphone is a ribbon microphone, a carbon microphone, fiber optic microphone (see, e.g., Paritsky and Kots (1997) “Fiber optic microphone as a realization of fiber optic positioning sensors” Proceedings of the International Society for Optical Engineering (SPIE). 10th Meeting on Optical Engineering in Israel. 3110: 408-09, incorporated herein by reference), a laser microphone, or a microelectrical-mechanical system (MEMS) microphone. In some embodiments, the microphone detects acoustic signals produced by impacts of hydrometeors on the detection surface. Transformation, processing, and analysis of the acoustic signal provides information characterizing the hydrometeors (e.g., hail stones) impacting the detection surface. In some embodiments, the apparatus comprises an acoustic sensor and a piezoelectric component used to verify that a sound signal detected by the acoustic sensor is real and not noise.

In some embodiments, e.g., as pictured in FIG. 3, the detection plate is affixed with multiple accelerometers. In some embodiments, an individual accelerometer is used to detect impacts across the panel surface or, in some embodiments, multiple sensors are used to detect impacts across the panel surface. In embodiments comprising multiple accelerometers, one or more of the difference in timing, difference in magnitude, and/or other characteristics of the signal detected by a first accelerometer relative to the signal detected by a second accelerometer is/are used to record the approximate location of the impact on the detection plate.

In some embodiments, the apparatus does not comprise a piezoelectric sensor and/or other piezoelectric component. That is, in some embodiments, the apparatus is piezoelectric component-free.

In some embodiments, the apparatus comprises an analog to digital (A/D) convertor. In some embodiments, the hail detection device comprises an analog-to-digital converter capable of sampling signals output by the hail detection plate and/or sensors connected to the hail detection plate at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz). In some embodiments, the hail detection device comprises an analog-to-digital converter capable of sampling signals output by an array of sensors provided on the hail detection plate (e.g., a grid or mosaic array of small solid-state force sensors or a pressure sensitive screen) at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz). In some embodiments, the apparatus comprises a signal processor. In some embodiments, the hail detection device comprises a signal processor capable of sampling signals output by the hail detection plate and/or sensors connected to the hail detection plate at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz). In some embodiments, the hail detection device comprises a signal processor capable of sampling signals output by an array of sensors provided on the hail detection plate (e.g., a grid or mosaic array of small solid-state force sensors or a pressure sensitive screen) at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz).

In some embodiments, one or more sensors are provided in a sensor pack. In some embodiments, the sensor pack is weatherized, weather resistant, and/or weatherproof. That is, in some embodiments, the sensor pack comprises an enclosure that encases and protects the sensors from weather (e.g., rain, humidity, etc.), environmental exposure (e.g., dust, wind, etc.), and/or tampering (e.g., by a human, animal, etc.) In some embodiments, the sensor pack comprises a case comprising a weather resistant and/or weatherproof material (e.g., a plastic, a metal) and, optionally, gaskets and/or seals to prevent entry of water, dust, etc. into the sensor pack. In some embodiments, the sensor pack is affixed to the underside of the detection panel.

In some embodiments, a sensor pack comprises input and/or output connectors for connection to another component, e.g., for transmitting power, communicating signals, and/or transferring data between sensors or other components inside the sensor pack and one or more components outside the sensor pack.

In some embodiments, a sensor pack comprises an altimeter, e.g., to determine the altitude of an apparatus (e.g., an apparatus to which the sensor pack is attached) above sea level.

In some embodiments, the sensor pack further comprises a component for transmission and/or receipt of data (e.g., a Dedicated Short Range Communications (DSRC), GPS, cellular (e.g., 4G, 5G), BLUETOOTH, LORA, Sigfox, LPWAN, and/or WiFi (e.g., (IEEE 802.11 (e.g., Wi-Fi 4, 5, 6, etc. standard))) radio). In some embodiments, the sensor pack comprises an antenna.

In some embodiments, the sensor pack comprises an analog-to-digital converter, e.g., an analog-to-digital converter configured to sample signals output by the hail detection plate and/or sensors connected to the hail detection plate at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz). In some embodiments, the sensor pack comprises an analog-to-digital converter configured to sample signals output by an array of sensors provided on the hail detection plate (e.g., a grid or mosaic array of small solid-state force sensors or a pressure sensitive screen) at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz).

In some embodiments, the sensor pack comprises a component for storage of data and/or computer instructions (e.g., a non-transitory, tangible computer-readable medium (e.g., a magnetic tape-based, a magnetic disc-based, and/or a flash memory-based medium). In some embodiments, the component for storage of data is a buffer configured to store sampled data (e.g., ultra-high-sample rate data). In some embodiments, the sensor pack comprises a microprocessor. In some embodiments, the sensor pack comprises one or more light producing components (e.g., a light emitting diode (LED), a liquid crystal display (LCD), incandescent light, fluorescent light, etc.) to indicate a status of one or more sensors, to indicate transmission and/or receipt of data, to indicate an error state, to indicate adequate power is being provided to the sensor pack, and/or to transmit a message and/or a code (e.g., a series of characters) to a user or to an external component comprising a light sensor. In some embodiments, the sensor pack comprises a speaker to produce an audible or human inaudible tone to indicate a status of one or more sensors, to indicate transmission and/or receipt of data, to indicate an error state, to indicate adequate power is being provided to the sensor pack, and/or to transmit a message and/or a code to a user or to an external component comprising a microphone. In some embodiments, the sensor pack comprises a battery to store and/or to provide a voltage (e.g., to store power).

In some embodiments, the sensor and/or sensor pack is affixed to the underside of the detection panel. Conventional contact (e.g., piezoelectric) sensor-based technologies that measure forces on a surface through a physically attached contact sensor (e.g., piezoelectric device) are highly dependent on the nature and quality of the attachment of the piezoelectric device to the surface. In particular, the accurate transmission of physical movement of the surface to the contact sensor (e.g., the piezoelectric component) depends stringently on the type and quality of attachment component and/or compound used to affix the contact sensor to the surface. Accordingly, conventional technologies comprising piezoelectric components physically connected and/or attached to an impact surface are associated with unpredictable unit-to-unit variability and signal infidelity. Further, piezoelectric components have an intrinsically non-flat bandwidth, which causes the frequency dependent nature of the piezoelectric component response to depend both on the individual sensor and the exact characteristics of the attachment, which are hard to decouple from each other.

In contrast, the present technology is less dependent on the quality of the attachment of sensors as described herein to the detection plate as described herein. For example, in some embodiments, the sensor and/or sensor pack is affixed to the underside of the detection panel with an adhesive (e.g., a caulk, glue, tape, putty, sealant, rubber, etc.). In some embodiments, the sensor and/or sensor pack is affixed to the underside of the detection panel with an adhesive that can be used in the field by a technician installing the hydrometeor apparatus or kit. In some embodiments, the sensor and/or sensor pack is affixed to the underside of the detection panel with a magnet.

In some embodiments, the apparatus further comprises a component for transmission and/or receipt of data (e.g., a Dedicated Short Range Communications (DSRC), GPS, cellular (e.g., 4G, 5G), BLUETOOTH, LORA, Sigfox, LPWAN, and/or WiFi (e.g., (IEEE 802.11 (e.g., Wi-Fi 4, 5, 6, etc. standard))) radio. In some embodiments, the apparatus comprises an antenna.

In some embodiments, the apparatus comprises a component for storage of data and/or computer instructions (e.g., a non-transitory, tangible computer-readable medium (e.g., a magnetic tape-based, a magnetic disc-based, and/or a flash memory-based medium). In some embodiments, the component for storage of data is a buffer configured to store sampled data (e.g., ultra-high-sample rate data). In some embodiments, the apparatus comprises a microprocessor. In some embodiments, the apparatus comprises one or more light producing components (e.g., a light emitting diode (LED), a liquid crystal display (LCD), incandescent light, fluorescent light, etc.) to indicate a status of one or more sensors, to indicate transmission and/or receipt of data, to indicate an error state, to indicate adequate power is being provided to the apparatus, and/or to transmit a message and/or a code to a user or to an external component comprising a light sensor. In some embodiments, the apparatus comprises a speaker to produce an audible or human inaudible tone to indicate a status of one or more sensors, to indicate transmission and/or receipt of data, to indicate an error state, to indicate adequate power is being provided to the apparatus, and/or to transmit a message and/or a code to a user or to an external component comprising a microphone. In some embodiments, the apparatus comprises a battery to store and/or to provide a voltage (e.g., to store power).

In some embodiments, the apparatus and/or sensor pack comprises a processor, e.g., for executing computer-executable program instructions (e.g., stored in a memory) to perform steps of an algorithm, calculate a mathematical model, process data, filter data, control electronic circuits, control sensors, and/or to manage data storage and/or data transfer. Exemplary processors include, e.g., a microprocessor, an ASIC, and a state machine and can be any of a number of computer processors. Such processors include, or may be in communication with, media, for example computer-readable media, which stores instructions that, when executed by the processor, cause the processor to perform steps described herein. In some embodiments, the microprocessor is configured to perform instructions encoded in software.

In some embodiments, the apparatus is designed to log and/or to transmit data. In some embodiments, data (e.g., hydrometeor impact data) are transmitted immediately subsequent to collection (e.g., in real-time). In some embodiments, data (e.g., hydrometeor impact data) are transmitted after logging and a period of milliseconds, seconds, minutes, hours, and/or days has passed. In some embodiments, the apparatus is designed to store sampled data (e.g., ultra-high-sample rate data) in a data buffer and transmit, use, and/or process hydrometeor data describing a hydrometeor impact when a hydrometeor is detected. In some embodiments comprising a logging component and/or system may, data is obtained by field service of the apparatus. In some embodiments, a wireless communication component (e.g., a Dedicated Short Range Communications (DSRC), GPS, cellular (e.g., 4G, 5G), BLUETOOTH, LORA, Sigfox, LPWAN, and/or WiFi (e.g., (IEEE 802.11 (e.g., Wi-Fi 4, 5, 6, etc. standard))) radio is used to maintain constant or partial communication with the apparatus. In some embodiments, the apparatus logs data and a technician is located within a range to transfer data wirelessly (e.g., by BLUETOOTH or another short-range communication method) or using a wired connection.

In some embodiments, the apparatus comprises an elastic covering component. In some embodiments, the elastic covering component covers a portion of the top surface of the detection plate. In some embodiments, the elastic covering component covers the entire top surface of the detection plate.

In some embodiments, elastic covering component prevents a hailstone from breaking apart upon impacting the apparatus, thus providing a technology to record the elastic collisions of hailstones with the apparatus. That is, in some embodiments, the elastic material maintains and/or preserves, substantially maintains and/or preserves, effectively maintains and/or preserves, and/or detectably maintains and/or preserves the elasticity of impact collisions. Measurements of the kinetic energy of hailstones that fracture upon impact are less reliable because an unknown and/or undetectable amount of kinetic energy is lost during the impact. Accordingly, the technology comprises embodiments of an apparatus that provides an improved, e.g., more reliable and consistent, characterization of the kinetic energy, mass, and/or velocity of hailstones because the impact of collisions occurs elastically. Furthermore, in some embodiments, the elastic covering component protects the detection plate from damage from hailstone (or other) impacts.

In some embodiments, the elastic covering component is a meshed material (e.g., a mesh) or a net. In some embodiments, the elastic covering component is a foam (e.g., sponge material). In some embodiments, the elastic covering component comprises a membrane, a gel, a semi-solid, and/or a liquid-filled bag. In some embodiments, the elastic covering component is a polymer (e.g., a rubber). For example, in some embodiments, the elastic covering is a silicone rubber.

In some embodiments, the elastic covering component is optically clear (e.g., transparent) and/or translucent (e.g., to allow light (e.g., sunlight) to contact a detection plate that comprises and/or is a solar panel). In particular, embodiments provide that the elastic covering component is at least partially, effectively, substantially, and/or completely transparent to light having a wavelength over approximately 1100 nm, e.g., to excite silicon valence electrons into the conduction band for producing electric current.

In some embodiments, the elastic covering component is resistant to degradation by ultraviolet radiation. For example, in some embodiments, the elastic covering component is clear rubber that is stabilized against breakdown by ultraviolet radiation. In some embodiments, the elastic covering component comprises portions that are opaque to light but that also comprises portions that are optically clear (e.g., transparent) and/or translucent to light, e.g., a meshed material or net made from an opaque material and having spaces through which light may pass to the solar panel.

In some embodiments, the apparatus comprises a force (e.g., touch) sensitive covering component on the top surface of the detection plate. In some embodiments, the force (e.g., touch) sensitive covering component on the top surface of the detection plate is an impact-sensitive component. In some embodiments, the force sensitive component comprises a capacitive touchscreen. In some embodiments, the force sensitive component is used to determine the physical impact locations of individual hailstones. In some embodiments, the force sensitive component is used to estimate the characteristics of individual hailstones.

In some embodiments, the apparatus comprises a detection plate and one or more force sensors (see, e.g., FIG. 4). In some embodiments, the apparatus further comprises a supporting frame. In some embodiments, the apparatus comprises a detection plate, a supporting frame, and one or more force sensors between the detection plate and the supporting frame. In some embodiments, a component comprising the detection plate and force sensors (e.g., as shown in FIG. 4) is attached (e.g., with bolts or other attachment component known in the art) to the supporting frame. In some embodiments, attaching the component comprising the detection plate and force sensors (e.g., as shown in FIG. 4) to the supporting frame provides the force sensors with a pre-load. In some embodiments, the force sensors comprise one or more of a strain gauge, load cell, semiconductor strain gauge, piezo crystal, resistive element, capacitive element, and/or inductive element. In some embodiments, the supporting frame is installed on an existing structure and the detection plate and one or more force sensors and/or component comprising the detection plate and force sensors is attached to the installed supporting frame (e.g., with bolts or other attachment component known in the art). In some embodiments, the detection plate is a solar panel (e.g., a photovoltaic panel). In some embodiments, when the apparatus is installed upon a stationary surface or attached to a mounting bracket, the sensors detect impacts of hydrometeors upon the detection plate. In some embodiments, the sensors are “sandwiched” between the supporting frame and the detection plate. Accordingly, embodiments provide that the difference in timing, magnitude, and other characteristics of the signals detected by the multiple sensors are used to record the approximate location of the impact on the detection plate.

In some embodiments, the apparatus comprises a GPS receiver. In some embodiments, the GPS receiver provides geographical information (e.g., the location (e.g., coordinates (e.g., latitude and longitude)) of the apparatus (e.g., on the earth)). In some embodiments, geographical information is used to analyze a storm. In some embodiments, geographical information is used to analyze a storm at a network level. In some embodiments, the geographical information finds use to assign an individual hailstone a precise impact time. In some embodiments, the GPS receiver provides time information that is associated with an individual hailstone, e.g., to provide a precise time of impact for a hailstone.

In some embodiments, the apparatus comprises an accelerometer. In some embodiments, the accelerometer is a multiple-axis accelerometer. In some embodiments, the apparatus uses a steady-state reading from an accelerometer, e.g., to determine the rotation of the detection plate around one, two, or three axes. In some embodiments, accelerometer data (e.g., describing the rotation of the detection plate around one, two, or three axes relative to a frame of reference (e.g., the earth)) provides information for calibrating the apparatus to account for the angle of installation in one, two, or three axes (e.g., relative to a frame of reference (e.g., the earth)). In some embodiments, the placement and attachment angle of the apparatus determines an initial state of a sensor. Thus, embodiments provide methods comprising establishing a null point as a zero force vector or baseline. In some embodiments, methods comprise receiving a signal from an accelerometer, e.g., to sense the gravitational alignment of the device with respect to the earth.

In some embodiments, the apparatus comprises a magnetometer. In some embodiments, magnetometer data is used to determine the orientation of the detection plate with respect to north. In some embodiments, magnetometer information is used to analyze a storm. In some embodiments, magnetometer information is used to analyze a storm at a network level. Moreover, in some embodiments, the apparatus comprises magnetometer to calibrate hydrometeor direction with respect to north despite any variable alignment of the device.

In some embodiments, the apparatus comprises on-board temperature and humidity sensors to compensate for temperature dependent effects.

In some embodiments, the apparatus comprises a light sensor, image sensor, and/or image recorder (e.g., a camera to record still images and/or a series of still images (e.g., a movie)). In some embodiments, the apparatus comprises an image sensor that comprises a charge-coupled device, an active pixel sensor, a complementary metal-oxide-semiconductor (CMOS) sensor, an N-type metal-oxide-semiconductor sensor, or a quanta image sensor (QIS).

In some embodiments, the detection plate is assembled with other components as described herein to provide protection to a roof and to provide hydrometeor impact data. For instance, in some embodiments, the detection plate comprises a shingle or other roof covering. In some embodiments, the detection surface comprises a component of a roof heating, ventilation, and air conditioning (HVAC) system.

Power to the device may be supplied in various methods. In some embodiments, the apparatus comprises a component to provide power to electrical components. In some embodiments, power from a nearby solar panel or renewable energy device is transmitted to the sensor pack. In some embodiments, power is supplied to the apparatus and/or to a rechargeable battery. In some embodiments, a power supply is a post-inverter component provided in a grid inter-tied solar power system that generates alternating current (AC) power and the energy is harvested by non-contact methods. In some embodiments, the apparatus comprises a solar panel. In some embodiments in which the apparatus comprises a solar panel, the apparatus comprises a rechargeable battery. In some embodiments in which the detection plate comprises and/or is a solar panel, the apparatus comprises a rechargeable battery. In some embodiments in which the apparatus comprises a solar panel and the detection plate does not comprise and is not said solar panel, the apparatus comprises a rechargeable battery. In some embodiments, the apparatus is powered directly by grid power. In some embodiments, sampling (e.g., frequent sampling) of the power is used to detect impacts on the detection plate. In some embodiments, an impact produces an impulse on the output of the detection panel. In some embodiments, a sufficiently large impact damages the panel and reduces and/or eliminates output power.

### Impact Detection

In some embodiments, impact detection comprises sampling the sensors at a high frequency and identifying large spikes in the signal. In some embodiments, “high frequency” sampling of a signal for a physical impact (e.g., as recorded by an accelerometer and/or a sensor) is a frequency of sampling that is approximately 8 to 12 kHz (e.g., approximately 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, or 12.0 kHz). In some embodiments, a “high frequency” sampling of a signal for a physical impact (e.g., as recorded by an acoustic sensor) is a frequency of sampling that is approximately 28 to 42 kHz (e.g., approximately 28.0, 28.1, 28.2, 28.3, 28.4, 28.5, 28.6, 28.7, 28.8, 28.9, 29.0, 29.1, 29.2, 29.3, 29.4, 29.5, 29.6, 29.7, 29.8, 29.9, 30.0, 30.1, 30.2, 30.3, 30.4, 30.5, 30.6, 30.7, 30.8, 30.9, 31.0, 31.1, 31.2, 31.3, 31.4, 31.5, 31.6, 31.7, 31.8, 31.9, 32.0, 32.1, 32.2, 32.3, 32.4, 32.5, 32.6, 32.7, 32.8, 32.9, 33.0, 33.1, 33.2, 33.3, 33.4, 33.5, 33.6, 33.7, 33.8, 33.9, 34.0, 34.1, 34.2, 34.3, 34.4, 34.5, 34.6, 34.7, 34.8, 34.9, 35.0, 35.1, 35.2, 35.3, 35.4, 35.5, 35.6, 35.7, 35.8, 35.9, 36.0, 36.1, 36.2, 36.3, 36.4, 36.5, 36.6, 36.7, 36.8, 36.9, 37.0, 37.1, 37.2, 37.3, 37.4, 37.5, 37.6, 37.7, 37.8, 37.9, 38.0, 38.1, 38.2, 38.3, 38.4, 38.5, 38.6, 38.7, 38.8, 38.9, 39.0, 39.1, 39.2, 39.3, 39.4, 39.5, 39.6, 39.7, 39.8, 39.9, 40.0, 40.1, 40.2, 40.3, 40.4, 40.5, 40.6, 40.7, 40.8, 40.9, 41.0, 41.1, 41.2, 41.3, 41.4, 41.5, 41.6, 41.7, 41.8, 41.9, or 42.0 kHz). In some embodiments, impact detection comprises sampling the signal produced by one or more sensors at an ultra-high frequency and identifying large spikes in the signal. In some embodiments, “ultra-high frequency” sampling of a signal for a physical impact (e.g., as recorded by an accelerometer and/or a force sensor) is a frequency of sampling that is approximately 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)).

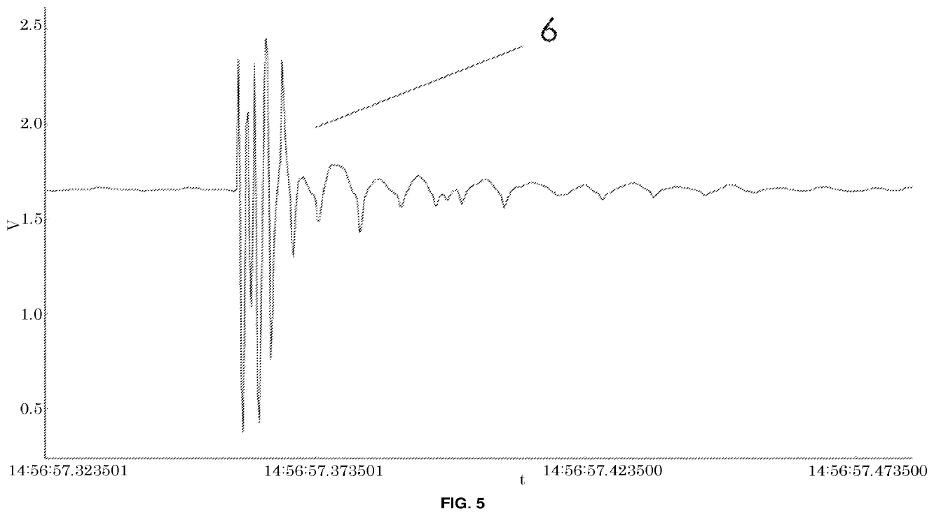

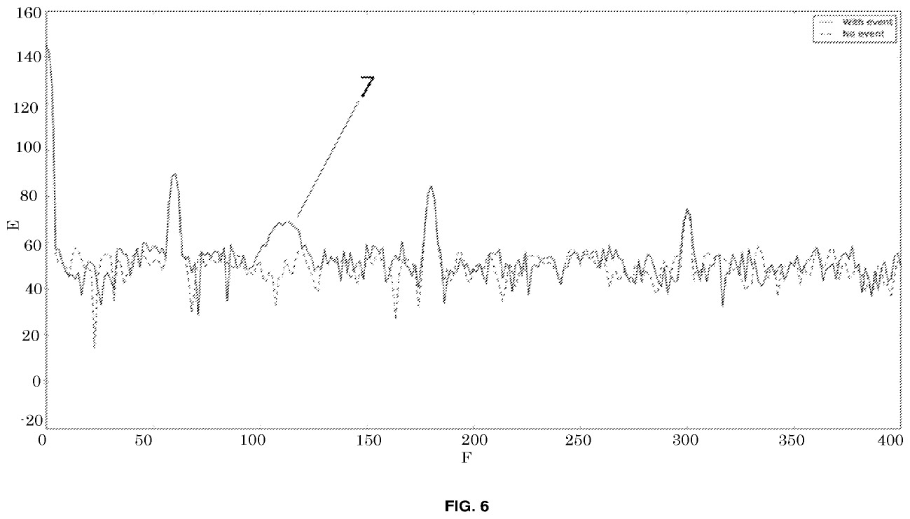

FIG. 5 shows exemplary data recorded by an embodiment of an apparatus as described herein detecting an impact. The sensor is biased at an offset value and records a transient spike (e.g., similar to a decaying sinusoid) produced by a hail stone impacting the detection plate. Embodiments provide that the frequency content of this signal is analyzed to determine characteristics of the impact. For example, a hailstone impact signature in the frequency domain is shown in FIG. 6.

In some embodiments, data from a plurality of different sensor types are collected and/or fused (e.g., by data fusion and/or data integrated methods) to provide an improved detection of hydrometeor impacts (e.g., hail impacts). For example, some embodiments provide an apparatus comprising an acoustic sensor and an accelerometer. However, the technology is not limited to embodiments comprising an acoustic sensor and an accelerometer and encompasses embodiments comprising two (or more) sensor types to provide an improved detection and/or characterization of hydrometeor (e.g., hail) impacts.

### Methods

In some embodiments, the technology provides methods of detecting hydrometeor impacts (e.g., hail impacts). In some embodiments, methods comprise providing a detection plate and a sensor; and attaching the sensor to the detection plate (e.g., with a composition comprising an adhesive) to provide an apparatus as described herein. In some embodiments, methods comprise identifying a component to use as a detection plate; and attaching the sensor to the detection plate. In some embodiments, the component to use as a detection plate is a solar panel. In some embodiments, the component to use as a detection plate has been previously installed. In some embodiments, the component to use as a detection plate is installed with the sensor to provide an apparatus as described herein.

In some embodiments, methods comprise providing a detection plate and a sensor pack (e.g., comprising a plurality of sensors); and attaching the sensor pack to the detection plate (e.g., with a composition comprising an adhesive) to provide an apparatus as described herein. In some embodiments, methods comprise identifying a component to use as a detection plate; and attaching the sensor pack to the detection plate. In some embodiments, the component to use as a detection plate is a solar panel. In some embodiments, the component to use as a detection plate has been previously installed. In some embodiments, the component to use as a detection plate is installed with the sensor pack to provide an apparatus as described herein. In some embodiments, the detection plate is a rigid detection plate. In some embodiments, the detection plate comprises force sensors capable of measuring the total force and position of a hailstone strike (e.g., a grid or mosaic array of small solid-state force sensors, or a pressure sensitive screen, among others). In some embodiments, the detection plate is a rigid detection plate comprising instrumentation that detects forces on the detection plate and/or acceleration of the detection plate at short time scales (e.g., 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁷ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10-seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁵ seconds or slower) by sampling at a sufficiently high rate (e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)) to provide improved peak stress measurements of force and/or acceleration. In some embodiments, the rigid detection plate comprises an analog-to-digital converter capable of sampling at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz).

In some embodiments, methods further comprise providing an elastic covering component. In some embodiments, methods further comprise covering the top surface of a detection plate with the elastic covering component.

In some embodiments, methods comprise providing an apparatus as described herein (e.g., comprising a detection plate and a sensor; and/or comprising a detection plate, a sensor, and an elastic covering component). In some embodiments, methods comprise assembling an apparatus as described herein (e.g., comprising a detection plate and a sensor; and/or comprising a detection plate, a sensor, and an elastic covering component). In some embodiments, methods comprise providing an apparatus as described herein (e.g., comprising a detection plate and a sensor pack; and/or comprising a detection plate, a sensor pack, and an elastic covering component). In some embodiments, methods comprise assembling an apparatus as described herein (e.g., comprising a detection plate and a sensor, and/or comprising a detection plate, a sensor, and an elastic covering component.

In some embodiments, methods comprise receiving a signal from one or more sensors of an apparatus as described herein. In some embodiments, methods comprise transmitting a signal from one or more sensors of an apparatus as described herein.

In some embodiments, methods comprise recording data from one or more sensors of an apparatus as described herein. In some embodiments, methods comprise analyzing data from one or more sensors as described herein. In some embodiments, methods comprise identifying a hydrometeor impact using data recorded and/or provided by one or more sensors of an apparatus as described herein. In some embodiments, methods comprise determining a hydrometeor (e.g., hail stone) mass, a hydrometeor (e.g., hail stone) peak stress (e.g., peak force and/or peak acceleration), a hydrometeor (e.g., hail stone) volume, a hydrometeor (e.g., hail stone) momentum, a hydrometeor (e.g., hail stone) velocity, a hydrometeor (e.g., hail stone) composition, or a hydrometeor (e.g., hail stone) size (e.g., in one, two, or three dimensions). In some embodiments, methods comprise determining a frequency of hydrometeor (e.g., hail stone) impacts. In some embodiments, methods comprise determining the energy of one or more hydrometeor (e.g., hail stone) impacts. In some embodiments, methods comprise estimating and/or determining damage produced by one or more hydrometeor (e.g., hail stone) impacts. In some embodiments, methods comprise determining the location of one or more hydrometeor (e.g., hail stone) impacts on the detection plate. In some embodiments, methods comprise determining the geographic location (e.g., by a coordinate, by a latitude and longitude, etc.) of an apparatus impacted by one or more hydrometeors (e.g., hail stones). In some embodiments, determining the geographic location (e.g., by a coordinate, by a latitude and longitude, etc.) of an apparatus impacted by one or more hydrometeors (e.g., hail stones) comprises communicating with a global positioning system satellite.

In some embodiments, methods comprise determining a value or parameter associated with a plurality of hydrometeors (e.g., hail stones). In some embodiments, methods comprise determining a mean, median, mode, standard deviation, range, and/or distribution of one or more of values, e.g., hydrometeor (e.g., hail stone) mass, hydrometeor (e.g., hail stone) peak stress (e.g., peak force and/or peak acceleration), hydrometeor (e.g., hail stone) volume, hydrometeor (e.g., hail stone) momentum, hydrometeor (e.g., hail stone) velocity, hydrometeor (e.g., hail stone) composition, and/or hydrometeor (e.g., hail stone) size (e.g., in one, two, or three dimensions); frequency of hydrometeor (e.g., hail stone) impacts; and/or energy of hydrometeor (e.g., hail stone) impacts. In some embodiments, methods comprise determining the geographic location (e.g., by a coordinate, by a latitude and longitude, etc.) of a plurality of apparatuses impacted by one or more hydrometeors (e.g., hail stones). In some embodiments, methods comprise producing a map of hydrometeor (e.g., hail stone) impacts (e.g., producing a map of apparatuses impacted by a hydrometeor (e.g., hail stone)).

In some embodiments, methods comprise recording data as a function of time. In some embodiments, methods comprise recording a discrete value associated with a time at which the discrete value was recorded. In some embodiments, methods comprise recording discrete values associated with the times at which the discrete values were recorded. Accordingly, in some embodiments, the methods comprise recording a time-series of data. In some embodiments, methods comprise interpolating to estimate a value between two recorded (e.g., measured) values. In some embodiments, methods comprise integrating data, e.g., to derive a value from the recorded data. In some embodiments, methods comprise calculating a derivative of data, e.g., to derive a value from the recorded data.

In some embodiments, methods comprise recording a series of data as a function of time. In some embodiments, the device is subject to multiple types and/or sources of forces, e.g., sometimes simultaneously and sometimes periodically throughout a time that said data are recorded. For example, forces on the device caused by wind, rain, and hydrometeor impacts produce low signals comprising one or more frequencies. Accordingly, in some embodiments, methods relate to discriminating low-frequency phenomena (e.g., such as wind and rain) from high-frequency phenomena (e.g., such as hydrometeor (e.g., hail) impacts) recorded by an apparatus. In particular, in some embodiments methods comprise deconvoluting a high-frequency and a low-frequency component of a signal. In some embodiments, methods comprise using frequency domain analysis. In some embodiments, methods comprise deconvoluting a signal to derive an impulse train associated with hydrometeor events. In some embodiments, methods comprise signal processing, e.g., Fourier transform analysis, filtering methods (e.g., low-pass filtering, high-pass filtering, band-pass filtering), peak fitting, background correction, smoothing, etc. In some embodiments the methods comprise filtering noise from the recorded data.

In some embodiments, detecting a hydrometeor (e.g., hail stone) impact comprises sampling one or more sensors. In some embodiments, methods comprise sampling sensors at a high frequency. In some embodiments, methods comprise identifying a spike in the sensor signal. In some embodiments, “high frequency” sampling of a signal for a physical impact (e.g., as recorded by an accelerometer and/or other sensor) comprises sampling a signal at approximately 8 to 12 kHz (e.g., approximately 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, or 12.0 kHz). In some embodiments, “high frequency” sampling of a signal for a physical impact (e.g., as recorded by an acoustic sensor) comprises sampling a signal at approximately 28 to 42 kHz (e.g., approximately 28.0, 28.1, 28.2, 28.3, 28.4, 28.5, 28.6, 28.7, 28.8, 28.9, 29.0, 29.1, 29.2, 29.3, 29.4, 29.5, 29.6, 29.7, 29.8, 29.9, 30.0, 30.1, 30.2, 30.3, 30.4, 30.5, 30.6, 30.7, 30.8, 30.9, 31.0, 31.1, 31.2, 31.3, 31.4, 31.5, 31.6, 31.7, 31.8, 31.9, 32.0, 32.1, 32.2, 32.3, 32.4, 32.5, 32.6, 32.7, 32.8, 32.9, 33.0, 33.1, 33.2, 33.3, 33.4, 33.5, 33.6, 33.7, 33.8, 33.9, 34.0, 34.1, 34.2, 34.3, 34.4, 34.5, 34.6, 34.7, 34.8, 34.9, 35.0, 35.1, 35.2, 35.3, 35.4, 35.5, 35.6, 35.7, 35.8, 35.9, 36.0, 36.1, 36.2, 36.3, 36.4, 36.5, 36.6, 36.7, 36.8, 36.9, 37.0, 37.1, 37.2, 37.3, 37.4, 37.5, 37.6, 37.7, 37.8, 37.9, 38.0, 38.1, 38.2, 38.3, 38.4, 38.5, 38.6, 38.7, 38.8, 38.9, 39.0, 39.1, 39.2, 39.3, 39.4, 39.5, 39.6, 39.7, 39.8, 39.9, 40.0, 40.1, 40.2, 40.3, 40.4, 40.5, 40.6, 40.7, 40.8, 40.9, 41.0, 41.1, 41.2, 41.3, 41.4, 41.5, 41.6, 41.7, 41.8, 41.9, or 42.0 kHz).

In some embodiments, methods comprise sampling sensors at an ultra-high frequency. In some embodiments, methods comprise identifying a spike in the sensor signal. In some embodiments, “ultra-high frequency” sampling of a signal for a physical impact (e.g., as recorded by an accelerometer or other force sensor) comprises sampling a signal at approximately 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)). In some embodiments, methods comprise buffering ultra-high-sample rate data (e.g., produced by ultra-high-frequency sampling). In some embodiments, methods comprise buffering the ultra-high-sample rate data are and using, transmitting, and/or otherwise processing the ultra-high-sample rate data when a hailstone is detected.

In some embodiments, methods comprise recording and/or identifying a transient spike (e.g., similar to a decaying sinusoid) in a signal (e.g., produced by a hail stone impacting the detection plate). In some embodiments, methods comprise analyzing a sensor signal in the frequency domain. In some embodiments, methods comprise characterizing one or more hydrometeor (e.g., hail stone) impacts. In some embodiments, methods comprise recording data from a plurality of different sensor types (e.g., an acoustic sensor and an accelerometer).

In some embodiments, methods comprise calibrating an apparatus as described herein. In some embodiments, calibrating an apparatus comprises impacting an apparatus (e.g., a detection plate of an apparatus) with an object having a known mass, volume, size, velocity, energy, and/or momentum. In some embodiments, calibrating an apparatus further comprises recording a sensor signal produced by an object having a known mass, volume, size, velocity, energy, and/or momentum impacting an apparatus (e.g., a detection plate of an apparatus) as described herein. In some embodiments, calibrating an apparatus comprises impacting an apparatus (e.g., a detection plate of an apparatus) with a plurality of objects having known masses, volumes, sizes, velocities, energies, and/or momenta. In some embodiments, calibrating an apparatus comprises impacting an apparatus (e.g., a detection plate of an apparatus) with a plurality of objects having a known distribution and/or range of masses, volumes, sizes, velocities, energies, and/or momenta.

In some embodiments, calibrating an apparatus as described herein comprises impacting an apparatus (e.g., a detection plate of an apparatus) as described herein with an impact hammer, e.g., to produce an impact on the apparatus (e.g., a detection plate of an apparatus) having a known force, known energy, and/or known location on the detection plate. In some embodiments, calibrating an apparatus as described herein comprises recording a sensor signal produced by impacting an apparatus (e.g., a detection plate of an apparatus) with an impact hammer. In some embodiments, calibrating an apparatus as described herein comprises recording a sensor signal produced by impacting an apparatus (e.g., a detection plate of an apparatus) with an impact hammer at a known frequency. In some embodiments, methods comprise calibrating an apparatus at an assembly site (e.g., in a factory, a laboratory, a site near the site of installation, etc.) In some embodiments, methods comprise calibrating an apparatus at the site of installation (e.g., in the field). In some embodiments, methods comprise impacting an apparatus (e.g., a detection plate of an apparatus) with a known impact (e.g., having a known force, known energy, and/or known location on the detection plate) and determining the response of a sensor to the known impact. In some embodiments, a solar panel used as a detection plate is field-fitted with a sensor and/or sensor pack. In some embodiments, an impact hammer is used to calibrate the impact force for the given detection plate mounting configuration and sensor and/or sensor pack attachment method, dynamic damping properties, dynamic transfer function, and/or frequency response.

In some embodiments, the apparatus comprises a sensor (e.g., an accelerometer, a gyroscope, a magnetometer, a GPS receiver) to determine mounting angle upon installation and during use after installation. In some embodiments, the apparatus comprises electronics and/or a microprocessor programmed to calibrate the device, e.g., as a self-calibration. For example, hydrometeors and/or wind may cause the apparatus to shift or may deform the apparatus. In some embodiments, these phenomena are corrected by the calibration process. In some embodiments, the apparatus triggers an alarm to alert a user, e.g., if a catastrophic failure occurs. In some embodiments, the alarm is transmitted to a remote user, e.g., over a network such as a cellular network, a wireless network, a wired network, the internet, by an optical signal, etc.

In some embodiments, measurements and/or data provided by one or more sensors is/are used to calibrate the apparatus. In some embodiments, measurements and/or data provided by one or more sensors of a first apparatus is/are used to calibrate a second apparatus. In some embodiments, measurements and/or data provided by one or more of sensors is/are used to correct other measurements collected by the apparatus. In some embodiments, the measurements from multiple sensors are integrated to provide an accurate measure hydrometeor impacts. For example, in some embodiments, deviations in measurements due to temperature drift are corrected using sunlight and temperature readings. In some embodiments, a sound sensor is used to measure wind speed, wind gusts, and/or wind direction. In some embodiments, temperature differentials on the device are used to determine wind direction. In some embodiments, temperature data are used to adjust parameters related to the stiffness and/or pliability of the materials used to construct the apparatus, in particular the detection plate and/or elastic covering component.

In some embodiments, the placement and attachment angle of the apparatus determines an initial state of a sensor. Thus, embodiments provide methods comprising establishing a null point as a zero force vector or baseline. In some embodiments, methods comprise receiving a signal from an accelerometer, e.g., to sense the gravitational alignment of the device with respect to the earth. In some embodiments, methods comprise correcting a signal based on data received from a temperature and/or humidity sensors (e.g., to compensate for temperature dependent effects of one or more sensors). Moreover, in some embodiments, methods comprise calibrating hydrometeor direction with respect to north using a magnetometer of the apparatus. In some embodiments, methods comprise adjusting hydrometeor size, velocity, mass, acceleration, kinetic energy, momentum, etc. as measured by an apparatus as described herein for the altitude of said apparatus, e.g., with respect to sea level or another reference point (e.g., an altitude at which the apparatus (or a portion thereof) was build and/or calibrated).

In some embodiments, methods comprise converting an analog signal (e.g., output by a sensor) to a digital signal. In some embodiments, methods comprise converting an analog signal to a digital signal using an analog/digital (A/D) converter.

In some embodiments, methods comprise determining a vector (e.g., a velocity vector) for a hydrometeor (e.g., a hail stone). In some embodiments, methods comprise determining a vector in a two-dimensional coordinate system; in some embodiments, methods comprise determining a vector in a three-dimensional coordinate system. In some embodiments, the sensors reside within the coordinate system in which the vector is determined. In some embodiments, the sensors are used to establish the coordinate system used to determine the vector, e.g., in two dimensions, three dimensions, or more.

### Risk Evaluation and Weather Event Detection and Reporting

In some embodiments, the hail sensing device technology finds use for a parametric (“index-based) insurance product. In some embodiments, the technology relates to paying an insured a payout when an agreed-upon parameter (e.g., hail of a specified size detected at a specified geographic location) is satisfied.

In some embodiments, the technology provided herein relates to evaluating a risk of hail impact (e.g., a damaging hail impact) and/or detecting a hail impact and reporting said hail impact to a user or business entity (e.g., an insurance company). In some embodiments, the technology comprises obtaining, producing, and/or providing historical weather (e.g., hail) data for a defined geographical region and/or evaluating a risk of a future weather (e.g., hail) event for said geographical region.

In some embodiments, said historical weather data comprises satellite data. In some embodiments, said historical weather data is National Weather Service (NWS) and/or National Oceanic and Atmospheric Administration (NOAA) weather data. In some embodiments, said historical weather data is, e.g., NOAA NWS, National Climactic Data Center (NCDC), and/or National Severe Storms Laboratory (NSSL) data and/or other third-party (municipal or private) weather service data such as NEXt-Generation RADar (NEXRAD) data (e.g., S-band Doppler radar data in accordance with the IEEE Standard 521 (1984)), Terminal Doppler Weather Radar (TDWR) data, and/or weather metric, index, and/or algorithm data (e.g., Vertically Integrated Liquid (VIL) data, VIL density data, wind gust algorithm data, hail algorithm data, mesocyclone algorithm data, Tornado Vortex Signature (TVS) algorithm data, wind shear algorithm data, and/or Velocity Azimuth Display (VAD) Wind Profile (VWP) algorithm data. Weather data may comprise raw data (e.g., radar and/or satellite data, such as radar maximum and/or minimum readings), pre-filtered and/or processed data, and/or analyzed and/or derived data (e.g., algorithm results or outcomes such as wind speed, wind direction, hail size, hail type, maximum hail probability, hail duration, estimated cloud layer elevations (e.g., echo top), precipitation locations, durations, and/or accumulations, precipitation types, storm tracks, etc.). In some embodiments, weather data may comprise data from one or more of a variety of weather and/or weather-related sensors such as satellite sensors (e.g., imagery or otherwise), storm surge and/or water level sensors (e.g., stream or river level or flow sensors), temperature sensors, etc.

In some embodiments, said historical weather data comprises measurements of hail size, volume, mass, momentum, kinetic energy, acceleration, velocity, speed, and/or direction for one or more individual hail stones. In some embodiments, said historical weather data comprises measurements of mean, median, mode, range, standard deviation, and/or other statistical characterization of hail size, volume, mass, momentum, kinetic energy, acceleration, velocity, speed, and/or direction for a plurality of hail stones. In some embodiments, said historical weather data comprises measurements of hail size, volume, mass, momentum, kinetic energy, acceleration, velocity, speed, and/or direction for one or more individual hail stones as a function of time and/or location. In some embodiments, said historical weather data comprises measurements of mean, median, mode, range, standard deviation, and/or other statistical characterization of hail size, volume, mass, momentum, kinetic energy, acceleration, velocity, speed, and/or direction for a plurality of hail stones as a function of time and/or location.

In some embodiments, said historical weather data comprises weather data for the past 1 to 10 (e.g., 1, 2, 3, 4, 5, 6, 7, 8, 9, or 10), 1 to 100 (1, 10, 20, 30, 40, 50, 60, 70, 80, 90, and/or 100), and/or 1 to 1000 (e.g., 1, 100, 200, 300, 400, 500, 600, 700, 800, 900, or 1000) days. In some embodiments, said historical weather data comprises weather data for the past 1 to 10 (e.g., 1, 2, 3, 4, 5, 6, 7, 8, 9, or 10), 1 to 100 (1, 10, 20, 30, 40, 50, 60, 70, 80, 90, and/or 100), and/or 1 to 1000 (e.g., 1, 100, 200, 300, 400, 500, 600, 700, 800, 900, or 1000) weeks. In some embodiments, said historical weather data comprises weather data for the past 1 to 10 (e.g., 1, 2, 3, 4, 5, 6, 7, 8, 9, or 10), 1 to 100 (1, 10, 20, 30, 40, 50, 60, 70, 80, 90, and/or 100), and/or 1 to 1000 (e.g., 1, 100, 200, 300, 400, 500, 600, 700, 800, 900, or 1000) months. In some embodiments, said historical weather data comprises weather data for the past 1 to 100 (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100) years.

In some embodiments, the historical weather data is used to evaluate a risk of a weather event (e.g., hail) occurring in the next 1 to 10 (e.g., 1, 2, 3, 4, 5, 6, 7, 8, 9, or 10), 1 to 100 (1, 10, 20, 30, 40, 50, 60, 70, 80, 90, and/or 100), and/or 1 to 1000 (e.g., 1, 100, 200, 300, 400, 500, 600, 700, 800, 900, or 1000) days. In some embodiments, the historical weather data is used to evaluate a risk of a weather event (e.g., hail) occurring in the next 1 to 10 (e.g., 1, 2, 3, 4, 5, 6, 7, 8, 9, or 10), 1 to 100 (1, 10, 20, 30, 40, 50, 60, 70, 80, 90, and/or 100), and/or 1 to 1000 (e.g., 1, 100, 200, 300, 400, 500, 600, 700, 800, 900, or 1000) weeks.

In some embodiments, the technology relates to obtaining, producing, and/or providing historical weather (e.g., hail) data for a defined geographical region and/or evaluating a risk of a weather event (e.g., hail) for said defined geographical region. In some embodiments, the defined geographical region comprises 1 m²; 10 m²; 100 m²; 1000 m²; 10,000 m²; 100,000 m²; or more. In some embodiments, the defined geographical region comprises 10 to 100 to 100,000 m² (e.g., 10, 20, 30, 40, 50, 60, 70, 80, 90, or 100; 200; 300; 400; 500; 600; 700; 800; 900; 1000; 2000; 3000; 4000; 5000; 6000; 7000; 8000; 9000; 10,000; 20,000; 30,000; 40,000; 50,000; 60,000; 70,000; 80,000; 90,000; or 100,000 m²). As such, the defined geographic region for which data are collected may be, for example, an item of personal property (e.g., at a single residence and/or business (e.g., an automobile, a boat, an airplane, etc.), a single residence or business, a city block, a neighborhood, a town or city, a county, a state, a country, a continent, an ocean, or the entire planet, and any intermediate geographic region and/or political entity within this range.

In some embodiments, the technology associates a risk and/or detecting of a weather (e.g., hail) event with a location. In some embodiments, the technology associates a risk and/or detecting of a weather (e.g., hail) event with a location using geolocation data. In some embodiments, geolocation data comprises data descriptive of one or more coordinates such as x, y, and/or z coordinates, Global Positioning System (GPS) coordinates, latitude and longitude coordinates, easting and northing, etc. In some embodiments, the geolocation data may comprise location attribute and/or metadata and/or may be or include an indicator of uniqueness. Each specific point or location on earth, for example, may be assigned a particular identifier to uniquely address the point/location with respect to other points/locations. According to some embodiments, such as in the context of insurance processes, uniqueness may be defined with respect to a customer and/or potential customer, family, business, policy/product, risk (potential and/or actual), and/or claim. For example, a combination of a postal code and a street address may serve to distinguish a particular customer/policy from all other customers/policies for a particular insurance company.

In some embodiments, the technology comprises dividing the defined geographical region into an array of sub-regions and evaluating the risk of a weather event occurring for one or more of said sub-regions. In some embodiments, the technology comprises obtaining, producing, and/or providing historical weather (e.g., hail) data for one or more sub-regions and evaluating the risk of a weather event (e.g., hail) occurring for one or more other sub-regions for which historical weather (e.g., hail) data are not obtained, produced, and/or provided. In some embodiments, the technology comprises providing an apparatus as described herein at one or more sub-regions.

In some embodiments, obtaining, producing, and/or providing historical weather (e.g., hail) data comprises recording hail data using an apparatus as described herein. In some embodiments, hail data recorded using an apparatus as described herein is fused with historical data obtained from one or more other sources of weather (e.g., hail) data (e.g., satellite data, NOAA NWS, National Climactic Data Center (NCDC), and/or National Severe Storms Laboratory (NSSL) data, and/or other third-party (municipal or private) weather service data as described above.

Some embodiments relate to providing risk estimates for a stratified range of hail sizes. For example, in some embodiments, the technology comprises evaluating a risk that hail having a diameter of 0.5-0.75 inches will occur at or within a defined geographic region. In some embodiments, the technology comprises evaluating a risk that hail having a diameter of 0.75-1.00 inches will occur at or within a defined geographic region. In some embodiments, the technology comprises evaluating a risk that hail having a diameter of 1.00-1.25 inches will occur at or within a defined geographic region. In some embodiments, the technology comprises evaluating a risk that hail having a diameter of 1.25-1.50 inches will occur at or within a defined geographic region. In some embodiments, the technology comprises evaluating a risk that hail having a diameter of 1.50-1.75 inches will occur at or within a defined geographic region. In some embodiments, the technology comprises evaluating a risk that hail having a diameter of 1.75-2.00 inches will occur at or within a defined geographic region. In some embodiments, the technology comprises evaluating a risk that hail having a diameter of 2.00-2.25 inches will occur at or within a defined geographic region. In some embodiments, the technology comprises evaluating a risk that hail having a diameter of 2.25-2.50 inches will occur at or within a defined geographic region. In some embodiments, the technology comprises evaluating a risk that hail having a diameter of greater than 2.50 inches will occur at or within a defined geographic region.

In some embodiments, the technology comprises determining a premium (e.g., price) for an insurance product that pays an insured a payout when hail having a diameter of a specified size is detected for a defined geographic region. For example, in some embodiments, the technology comprises determining a premium (e.g., price) for an insurance product that pays an insured a payout when hail having a diameter of 0.5-0.75 inches is detected within a defined geographic region. In some embodiments, the technology comprises determining a premium (e.g., price) for an insurance product that pays an insured a payout when hail having a diameter of 0.75-1.00 inches is detected within a defined geographic region. In some embodiments, the technology comprises determining a premium (e.g., price) for an insurance product that pays an insured a payout when hail having a diameter of 1.00-1.25 inches is detected within a defined geographic region. In some embodiments, the technology comprises determining a premium (e.g., price) for an insurance product that pays an insured a payout when hail having a diameter of 1.25-1.50 inches is detected within a defined geographic region. In some embodiments, the technology comprises determining a premium (e.g., price) for an insurance product that pays an insured a payout when hail having a diameter of 1.50-1.75 inches is detected within a defined geographic region. In some embodiments, the technology comprises determining a premium (e.g., price) for an insurance product that pays an insured a payout when hail having a diameter of 1.75-2.00 inches is detected within a defined geographic region. In some embodiments, the technology comprises determining a premium (e.g., price) for an insurance product that pays an insured a payout when hail having a diameter of 2.00-2.25 inches is detected within a defined geographic region. In some embodiments, the technology comprises determining a premium (e.g., price) for an insurance product that pays an insured a payout when hail having a diameter of 2.25-2.50 inches is detected within a defined geographic region. In some embodiments, the technology comprises determining a premium (e.g., price) for an insurance product that pays an insured a payout when hail having a diameter of greater than 2.50 inches is detected within a defined geographic region.

In some embodiments, the premium is determined based on both the evaluated risk of hail of a specified size being detected within a defined geographic region and the negotiated amount of the payout to be paid upon detection of hail of a specified size being detected within said defined geographic region.

In some embodiments, the technology comprises setting a payment trigger for a defined geographic area that is a hail size and/or hail size range. For example, in some embodiments, the technology comprises setting a payment trigger that is a hail size having a diameter of 0.5-0.75 inches detected within a defined geographic region. In some embodiments, the technology comprises setting a payment trigger that is a hail size having a diameter of 0.75-1.00 inches detected within a defined geographic region. In some embodiments, the technology comprises setting a payment trigger that is a hail size having a diameter of 1.00-1.25 inches detected within a defined geographic region. In some embodiments, the technology comprises setting a payment trigger that is a hail size having a diameter of 1.25-1.50 inches detected within a defined geographic region. In some embodiments, the technology comprises setting a payment trigger that is a hail size having a diameter of 1.50-1.75 inches detected within a defined geographic region. In some embodiments, the technology comprises setting a payment trigger that is a hail size having a diameter of 1.75-2.00 inches detected within a defined geographic region. In some embodiments, the technology comprises setting a payment trigger that is a hail size having a diameter of 2.00-2.25 inches detected within a defined geographic region. In some embodiments, the technology comprises setting a payment trigger that is a hail size having a diameter of 2.25-2.50 inches detected within a defined geographic region. In some embodiments, the technology comprises setting a payment trigger that is a hail size having a diameter of greater than 2.50 inches detected within a defined geographic region.

In some embodiments, the technology comprises determining a plurality of premiums for a plurality of ranges of hail size diameters. In some embodiments, the technology comprises determining a plurality of payout amounts for a plurality of ranges of hail size diameters. In some embodiments, the technology comprises setting a plurality of payment triggers for a defined geographic region.

In some embodiments, the technology comprises measuring the size of one or more hail stones (e.g., that impact a device as described herein) within a defined geographic region. In some embodiments, the technology comprises comparing the measured size of one or more hail stones detected within a defined geographic area with a database of payment triggers. In some embodiments, the technology comprises identifying a payment trigger of the database of payment triggers that is less than the measured size of one or more hail stones detected within a defined geographic area. In some embodiments, the technology comprises identifying an insured associated with a payment trigger that is less than the measured size of one or more hail stones detected within a geographic area and paying a payout to said insured. In some embodiments, paying a payout is performed electronically, e.g., by a wire service, electric funds transfer, electronic check, virtual currency, credit card payment, peer-to-peer electronic transfer, etc.

In some embodiments, the technology comprises producing a database of hail size associated with geolocation data indicating the location where the hail was detected. In some embodiments, the technology comprises producing a database of insured individuals associated with payment triggers for the insured individuals. In some embodiments, one or more databases are stored in a blockchain (e.g., a distributed, decentralized, public ledger). In some embodiments, negotiated payment triggers (e.g., payout amounts, hail diameters, and insureds) are stored in a blockchain.

Some embodiments of the technology provided herein further comprise functionalities for collecting, storing, and/or analyzing data (e.g., historical weather (e.g., hail) data and/or real-time weather (e.g., hail) data detected by an apparatus as described herein). For example, in some embodiments the technology provides a processor, a memory, and/or a database for, e.g., storing and executing instructions, analyzing data, performing calculations using the data, transforming the data, and storing the data. In some embodiments, the processor, memory, and/or database are provided locally with the hail sensing device (e.g., the hail sensing device comprises said processor, memory, and/or database). In some embodiments, the processor, memory, and/or database are remote from the hail sensing device (e.g., on a remote server in communication (e.g., wireless communication) with the hail sensing device). In some embodiments, the processor is used to initiate and/or terminate measurement and data collection by a hail sensing device described herein. In some embodiments, the technology provides a user interface (e.g., a keyboard, buttons, dials, switches, and the like) for receiving user input that is used by the processor to process and/or analyze a measurement. In some embodiments, the hail sensing device described herein further comprises a data output for transmitting data to an external destination, e.g., a computer, a display, a network, and/or an external storage medium. Some embodiments provide a device that is a small, handheld, portable device incorporating these features and components that is in communication with a hail sensing device and/or with a remote server to display hail impact data and analysis of hail impact data. For example, in some embodiments, the hail sensing device communicates weather (e.g., hail) data to a remote server and the remote server sends weather (e.g., hail) data to a portable device of an insured. In some embodiments, the remote server sends an indication to an insured that a payment trigger has been met by a measured parameter (e.g., diameter) of hail at a geographical region.

### Kits

In some embodiments, the technology provides kits for assembling an apparatus as provided herein. In some embodiments, kits comprise, consist of, and/or consist essentially of a detection plate and a sensor and/or sensor pack (e.g., comprising one or more sensors and/or an analog-to-digital convertor (e.g., an analog-to-digital convertor capable of ultra-high frequency sampling)). In some embodiments, kits comprise, consist of, and/or consist essentially of a detection plate, a sensor and/or sensor pack (e.g., comprising one or more sensors and/or an analog-to-digital convertor (e.g., an analog-to-digital convertor capable of ultra-high frequency sampling)), and an elastic covering component. In some embodiments, kits comprise a rigid detection plate that is fully instrumented to measure local forces on short (e.g., nanosecond, microsecond, or millisecond) timescales. In some embodiments, the rigid detection plate comprises force sensors capable of measuring the total force and position of a hailstone strike (e.g., a grid or mosaic array of small solid-state force sensors, or a pressure sensitive screen, among others). In some embodiments, the rigid detection plate comprises instrumentation that detects forces on the detection plate and/or acceleration of the detection plate at short time scales (e.g., 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁷ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10⁻⁶ seconds or slower; 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, or 9.0×10-5 seconds or slower) by sampling at a sufficiently high rate (e.g., 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz)) to provide improved peak stress measurements of force and/or acceleration. In some embodiments, the rigid detection plate comprises an analog-to-digital converter capable of sampling at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz). In some embodiments, kits comprise an analog-to-digital converter capable of sampling at 100 to 1000 to 10,000 kHz (e.g., 100, 200, 300, 400, 500, 600, 700, 800, 900, or 1000 kHz; 1000, 2000, 3000, 4000, 5000, 6000, 7000, 8000, 9000, or 10000 kHz).

In some embodiments, kits are used to assemble an apparatus as described herein using a detection plate that has been previously installed (e.g., a solar panel). In some embodiments, kits are used to assemble an apparatus as described herein while a detection plate is being installed (e.g., a solar panel). Accordingly, in some embodiments, kits comprise, consist of, and/or consist essentially of a sensor and/or a sensor pack. In some embodiments, kits comprise, consist of, and/or consist essentially of a sensor and/or a sensor pack and an elastic covering component. In some embodiments, kits comprise an adhesive or other composition for attaching and/or affixing the sensor and/or sensor pack to the detection plate. In some embodiments, kits comprise a support frame as described herein (e.g., for embodiments described herein that comprise “feet” comprising force sensors).

### Systems

In some embodiments, the technology relates to systems comprising embodiments of the apparatuses described herein. Exemplary embodiments of a system comprise an apparatus (e.g., a hail sensing apparatus) as described herein and a computer in communication with the apparatus. In some embodiments, the system comprises a second apparatus (e.g., a hail sensing apparatus) as described herein in communication with the first apparatus and/or in communication with the computer. In some embodiments, systems furthermore comprise a software component for implementing algorithms and models used to characterize hail impacts and to model hail storms based on the data collected from two or more apparatuses installed throughout a geographic region. In some embodiments, one or more of the apparatuses comprise a software component configured to calculate hail data from hail impacting the apparatus and, in some embodiments, hail impact data are transmitted to a computer that comprises a software component configured to calculate hail data from hail impacting the apparatus.

In some embodiments, a computer collects data from multiple apparatuses and comprises a software component to model weather patterns (e.g., hail storms) based on the data collected from two or more apparatuses installed throughout a geographic region. In some embodiments, the software component predicts future weather events, weather patterns, and/or hail storms. In some embodiments, systems further comprise an alerting component that issues an alert to a user or to another entity, e.g., for an action to be taken that is appropriate for the predicted weather events and/or hail storms. In some embodiments, systems are implemented, for example, in a network of apparatuses and, in some embodiments, computers. A geographic area may be covered by a network or “micro-grid” of the apparatuses in communication with each other and, in some embodiments, a computer (e.g., a data server) to analyze the data from multiple devices (e.g., configured to apply a statistical analysis of the data). In some embodiments, systems provide a historical record, provide real-time monitoring, and/or provide predictions of weather events such as storms (e.g., hail storms).

The technology is not limited by the distance or geographic area that separates two or more apparatuses or the geographic area for which the two or more apparatuses provides hail and/or impact data from multiple points. In some embodiments, the apparatuses are separated by 10 m; 100 m; 1000 m; 10,000 m; or more. In some embodiments, the apparatuses provide hail and/or impact data for a region that is 100 m²; 1000 m²; 10,000 m²; 100,000 m²; or more. In some embodiments, the apparatuses are placed at two or more points anywhere on the Earth, e.g., the apparatuses are placed within approximately 20,000 to 25,000 km of one another (the circumference of the earth is approximately 40,000 km). For example, in some embodiments two or more apparatuses are distributed over a region having an area of 100 to 100,000 m² (e.g., 100; 200; 300; 400; 500; 600; 700; 800; 900; 1000; 2000; 3000; 4000; 5000; 6000; 7000; 8000; 9000; 10,000; 20,000; 30,000; 40,000; 50,000; 60,000; 70,000; 80,000; 90,000; or 100,000 m²). In some embodiments, two or more apparatuses are separated from one another by 10 to 10,000 m (e.g., 10; 20; 30; 40; 50; 60; 70; 80; 90; 100; 200; 300; 400; 500; 600; 700; 800; 900; 1000; 2000; 3000; 4000; 5000; 6000; 7000; 8000; 9000; or 10,000 m). As such, the geographic region for which data are collected may be, for example, a single residence, a city block, a neighborhood, a town or city, a county, a state, a country, a continent, an ocean, or the entire planet, and any intermediate geographic region and/or political entity within this range. In some embodiments, the apparatuses are installed on land and/or at sea.

In some embodiments, the data from one or more apparatuses is processed by a computer to provide historical, real-time, or forecasted weather information (e.g., hail data and/or hail storm data) for a geographic area. In some embodiments, the historical, real-time, or forecasted weather information (e.g., hail data and/or hail storm data) is presented graphically to a user by a display. In some embodiments, weather information (e.g., hail data and/or hail storm data) from multiple points triggers an alert or an alarm that is transmitted to a user or service (e.g., over a telephone line, a cellular network, a wireless network, a wired network, the internet, by an optical signal, etc.) to prompt preparation for a weather event (e.g., hail and/or hail storm). In some embodiments, the data from one or more devices is processed by a computer using a model to predict the weather (e.g., hail and/or hail storm) at one or more geographic regions. In some embodiments, information about placement of the apparatus relative to buildings, trees, etc. is used to analyze weather information (e.g., hail data and/or hail storm data).

In some embodiments, the apparatuses, methods, kits, and systems described herein are associated with a programmable machine designed to perform a sequence of arithmetic or logical operations as provided by the methods described herein. For example, in some embodiments, the apparatus comprises a sensor, an analog to digital converter, and/or a microprocessor. For example, some embodiments of the technology are associated with (e.g., implemented in) computer software and/or computer hardware. In some embodiments, the technology relates to a computer comprising a form of memory, an element for performing arithmetic and logical operations, and a processing element (e.g., a microprocessor) for executing a series of instructions (e.g., a method as provided herein) to read, manipulate, and store data. In some embodiments, a microprocessor is part of a system for collecting and/or analyzing impact data. Some embodiments comprise a storage medium and memory components. Memory components (e.g., volatile and/or nonvolatile memory) find use in storing instructions (e.g., an embodiment of a process as provided herein) and/or data (e.g., a work piece such as impact data and/or a time series of impact data). Some embodiments relate to systems also comprising one or more of a CPU, a graphics card, and a user interface (e.g., comprising an output device such as display and an input device such as a keyboard). Programmable machines associated with the technology comprise conventional extant technologies and technologies in development or yet to be developed (e.g., a quantum computer, a chemical computer, a DNA computer, an optical computer, a spintronics based computer, etc.) In some embodiments, the technology comprises a wired (e.g., metallic cable, fiber optic) or wireless transmission medium for transmitting data. For example, some embodiments relate to data transmission over a network (e.g., a local area network (LAN), a wide area network (WAN), an ad-hoc network, the internet, etc.) In some embodiments, systems comprise one or more of a component for transmission and/or receipt of data over a wireless network (e.g., a Dedicated Short Range Communications (DSRC), GPS, cellular (e.g., 4G, 5G), BLUETOOTH, LORA, Sigfox, LPWAN, and/or WiFi (e.g., (IEEE 802.11 (e.g., Wi-Fi 4, 5, 6, etc. standard))) radio). In some embodiments, systems comprise one or more of an antenna.

In some embodiments, programmable machines are present on such a network as peers and in some embodiments the programmable machines have a client/server relationship.

In some embodiments, data are stored on a computer-readable storage medium such as a hard disk, flash memory, optical media, a floppy disk, etc.

In some embodiments, the technology provided herein is associated with a plurality of programmable devices that operate in concert to perform a method as described herein. For example, in some embodiments, a plurality of computers (e.g., connected by a network) may work in parallel to collect and process data, e.g., in an implementation of cluster computing or grid computing or some other distributed computer architecture that relies on complete computers (with onboard CPUs, storage, power supplies, network interfaces, etc.) connected to a network (private, public, or the internet) by a conventional network interface, such as Ethernet, fiber optic, or by a wireless network technology.

For example, some embodiments provide a computer that includes a computer-readable medium. The embodiment includes a random access memory (RAM) coupled to a processor. The processor executes computer-executable program instructions stored in memory. Such processors may include a microprocessor, an ASIC, a state machine, or other processor, and can be any of a number of computer processors, such as processors from Intel Corporation of Santa Clara, Calif. and Motorola Corporation of Schaumburg, Ill. Such processors include, or may be in communication with, media, for example computer-readable media, which stores instructions that, when executed by the processor, cause the processor to perform the steps described herein.

Embodiments of computer-readable media include, but are not limited to, an electronic, optical, magnetic, or other storage or transmission device capable of providing a processor with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, Swift, Julia, and JavaScript.

Computers are connected, in some embodiments, to a network. Computers may also include a number of external or internal devices such as a mouse, a CD-ROM, DVD, a keyboard, a display, or other input or output devices. Examples of computers are personal computers, digital assistants, personal digital assistants, cellular phones, mobile phones, smart phones, pagers, digital tablets, laptop computers, internet appliances, and other processor-based devices. In general, the computers related to aspects of the technology provided herein may be any type of processor-based platform that operates on any operating system, such as Microsoft Windows, Linux, UNIX, Mac OS X (macOS), a web-based soft client, thin client, etc., capable of supporting one or more programs comprising the technology provided herein. Some embodiments comprise a personal computer executing other application programs (e.g., applications). The applications can be contained in memory and can include, for example, a word processing application, a spreadsheet application, an email application, an instant messenger application, a presentation application, an Internet browser application, a calendar/organizer application, and any other application capable of being executed by a client device.

All such components, computers, and systems described herein as associated with the technology may be logical or virtual.

In some embodiments, a computer or system provides diagnostic information about one or more apparatuses provided herein. For example, in some embodiments, an apparatus, collection of apparatuses, and/or a system is able to self-check and/or report problems to a user. In some embodiments, a computer or system provides automatic calibration of a device, system, or collection of apparatuses.

### Uses

In some embodiments, the technology finds use in research and in the fields of commerce, insurance, and/or agriculture. For example, the technology finds use in some embodiments to collect hydrometeor (e.g., hail stone) and storm data for analysis, prediction, verification, etc. of storms (e.g., hail storms) in research and in the fields of commerce, insurance, and/or agriculture. In some embodiments, the technology finds use in evaluating the risk of a weather (e.g., hail) event and/or detecting a weather (e.g., hail) event for use in establishing an insurance premium and/or making a payout to an insured when a weather (e.g., hail) event is detected.

In some embodiments, the apparatus is installed parallel (and/or substantially or essentially parallel) to a roof. For instance, in some embodiments, the apparatus is installed parallel to a roof to measure impact forces normal to the roof surface, e.g., to access damageability and/or damage to a roof. In some embodiments, the apparatus is installed with the detection plate perpendicular (e.g., substantially and/or effectively perpendicular) to the gravity vector to normalize the angle of impact with respect to roof angle. In some embodiments, multiple apparatuses (e.g., 2, 3, 4, 5, 6, 7, 8, 9, 10, 20, 25, 30, 35, 40, 45, 50, 55, 60, 65, 70, 75, 80, 85, 90, 95, 100, 200, 300, 400, 500, or more) are installed in a geographical area. In some embodiments, the multiple apparatuses form a network. In some embodiments, the multiple apparatuses are used to record the areas subjected to hail and the associated impact strength (e.g., size, velocity, momentum, and mass) of hail. In some embodiments, hail data are used to check, verify, and/or predict hail damage to property.

The technology provides several advantages. For example, the technology is deployed with simpler logistics and lower costs relative to conventional technologies. In particular, providing a network of apparatuses is associated with production and real estate costs and installation logistics that are often difficult to overcome. Accordingly, the technology provided herein provides embodiments that are installed onto existing infrastructure that, in some embodiments, comprises an existing power source (e.g., solar panels). In some embodiments, the technology comprises use of an existing structure for a detection plate (e.g., an installed shingle, solar panel, HVAC unit, etc.).

Further, the technology provides a detection surface with a surface area adequate to detect a range of hail sizes, including large hail impacts, with enough sampling to provide reliable and useful data that can be assessed using hail size and frequency statistics for a given storm.

Embodiments provide an apparatus comprising multiple sensors and/or multiple types of sensors. For instance, embodiments comprise both an acoustic sensor and an accelerometer, thus avoiding problems associated with use of either sensor alone. In particular, a microphone can detect vibrations and acoustic power from phenomena that are not related to hydrometeor impacts on the detection plate surface and an accelerometer can produce varying signatures depending on the mounting method. However, in embodiments comprising two types of sensors, the hail signature is improved by analyzing data recorded by both sensors. The technology is not limited to embodiments comprising an acoustic sensor and an accelerometer and includes embodiments comprising two different types of sensors to provide an improved detection of hail impacts.

In some embodiments, data are collected from two or more apparatuses to provide impact data from multiple points in a geographic region. For example, multiple data sets from apparatuses separated from one another are used, e.g., for predictive and statistical analysis of storms and other weather events. In some embodiments, the two or more apparatuses communicate with one another other and in some embodiments the two or more apparatuses communicate with a computer (e.g., a data server) over a network (e.g., a cellular network, a wireless network, a wired network, the internet, by an optical signal, etc.). The technology is not limited by the distance or geographic area that separates two or more apparatuses or the geographic area for which the two or more apparatuses provides hail and/or impact data from multiple points. In some embodiments, the apparatuses are separated by 10 m; 100 m; 1000 m; 10,000 m; or more. In some embodiments, the apparatuses provide hail and/or impact data for a region that is 100 m²; 1000 m²; 10,000 m²; 100,000 m²; or more. In some embodiments, the apparatuses are placed at two or more points anywhere on the Earth, e.g., the apparatuses are placed within approximately 20,000 to 25,000 km of one another (the circumference of the earth is approximately 40,000 km). As such, the geographic region for which data are collected may be, for example, a single residence, a city block, a neighborhood, a town or city, a county, a state, a country, a continent, an ocean, or the entire planet, and any intermediate geographic region and/or political entity within this range.

Although the disclosure herein refers to certain illustrated embodiments, it is to be understood that these embodiments are presented by way of example and not by way of limitation.

### Example

An embodiment of the hail detection apparatus as described herein was constructed using a 20-W solar panel, a 200G impact accelerometer, a stiff adhesive to attach the accelerometer directly to the underside of the solar panel, a component for recording accelerometer data, and a component for wireless communication. A similar embodiment of the hail detection apparatus as described herein was constructed as above and included an elastic cover made from a clear silicone encapsulated rubber to cover the solar panel.

The solar panel was attached to a piece of wood that approximated the construction of a house using commonly used brackets and methods in the solar panel industry. Using a pneumatic cannon and lab-grown ice (e.g., to represent experimental hail stones), a high-pressure jet of air was used to accelerate the experimental hail stones of different sizes towards the solar panel. The accelerometer captured the high frequency spike related to the initial impact of the experimental hail stones on the detection panel and the subsequent oscillations associated with the natural frequency of the specific installation. The impact locations of the experimental hail stones on the detection panel were varied in both coordinates on the detection panel surface and the individual signatures of impacts were recorded. The mass, impact hardness, velocity, and size of the experimental hail stones were also recorded. Artificial hailstones were also used to minimize the effect of onset of fracture (yield stress variation). These features were clustered and analyzed for their effect on the attributes of the signal.

The impact signals and mass, impact hardness, velocity, and size of the experimental hail stones were analyzed. Overall, the analysis indicated a strong correlation between the mass of a given hailstone and the analyzed signal. Accordingly, the impact data collected by the hail detection apparatus and the analyzed signal was used to determine the mass of the hail stone. The calculated mass of the hail stone was used to calculate the size of the hail stone assuming a uniform density for the hail. However, density of hail may vary among hail stones and among hail storms. Thus, some embodiments comprise measuring the acoustic signatures of hail impacts to supplement the accelerometer data (e.g., analyzed accelerometer signals). The sizes and/or masses of hail stones can be measured and/or calculated independently of each other from the accelerometer and acoustic signals for hail stones having a range of densities and thus provide an improved (e.g., more accurate) determination of hail size and/or hail mass. Further, embodiments of the hail detection apparatus comprise more (e.g., a plurality of) transducers, which minimizes the variability of the signal as a function of impact location on the detection panel.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

We claim:

1. An apparatus comprising a detection plate and a sensor affixed to the underside of said detection plate.

2. The apparatus of claim 1 further comprising an elastic covering component.

3. The apparatus of claim 2 wherein said elastic covering component partially covers the top of the detection plate.

4. The apparatus of claim 2 wherein said elastic covering component fully covers the top of the detection plate.

5. The apparatus of claim 2 wherein said elastic covering component comprises a rubber, foam, membrane, meshed material, or net.

6. The apparatus of claim 2 wherein said elastic covering component permits transmission of light.

7. The apparatus of claim 2 wherein said elastic covering component permits transmission of sunlight.

8. The apparatus of claim 2 wherein said elastic covering component permits transmission of electromagnetic radiation having a wavelength greater than approximately 1100 nm.

9. The apparatus of claim 2 wherein said elastic covering component permits transmission of light sufficient to produce electric current by a photovoltaic panel.

10. The apparatus of claim 2 wherein said elastic covering component comprises silicone.

11. The apparatus of claim 1 wherein said detection plate comprises a solar panel.

12. The apparatus of claim 1 wherein said sensor is an accelerometer.

13. The apparatus of claim 1 wherein said sensor is an acoustic sensor.

14. The apparatus of claim 1 wherein said sensor is a force sensor.

15. The apparatus of claim 14 wherein said force sensor comprises a load cell.

16. The apparatus of claim 1 further comprising a second sensor that is a vibration sensor, a gyroscope, a magnetometer, a temperature sensor, a humidity sensor, a particulate sensor, a sensor of electromagnetic radiation, an atmospheric pressure sensor, a solar energy incidence sensor, a solar flux sensor, a wind speed sensor, a proximity sensor, or an image sensor.

17. The apparatus of claim 1 wherein said detection plate has an area of at least 3.5 square feet to 100 square feet.

18. The apparatus of claim 1 further comprising a microprocessor.

19. The apparatus of claim 13 wherein said microprocessor is configured to receive inputs from said sensor.

20. The apparatus of claim 13 wherein said microprocessor is configured to calculate hydrometeor impact data.

21. The apparatus of claim 13 wherein said microprocessor is configured to receive inputs from a plurality of sensors.

22. The apparatus of claim 13 wherein said microprocessor is configured to calculate hydrometeor impact data from multiple sensor signals.

23. The apparatus of claim 13 wherein said microprocessor is configured to calculate hydrometeor impact data comprising hydrometeor size, hydrometeor volume, hydrometeor mass, hydrometeor momentum, hydrometeor energy, and/or hydrometeor velocity.

24. The apparatus of claim 13 wherein said microprocessor is configured to calculate a distribution, range, mean, mode, and/or median of one or more of hydrometeor impact data comprising hydrometeor size, hydrometeor volume, hydrometeor mass, hydrometeor momentum, hydrometeor energy, and/or hydrometeor velocity for a plurality of hydrometeors.

25. The apparatus of claim 1 further comprising a supporting frame.

26. The apparatus of claim 25 further comprising a force sensor between said supporting frame and said detection plate.

27. The apparatus of claim 1 further comprising a global navigation satellite system receiver, a wireless communications radio, and/or an antenna.

28. An apparatus comprising a detection plate and a sensor pack affixed to the underside of said detection plate.

29. The apparatus of claim 28 wherein said sensor pack comprises a plurality of sensors.

30. The apparatus of claim 28 wherein said sensor pack comprises a weatherized enclosure.

31. The apparatus of claim 28 wherein said sensor pack comprises an accelerometer.

32. The apparatus of claim 28 wherein said sensor pack comprises an acoustic sensor.

33. The apparatus of claim 28 wherein said sensor pack comprises a component for data transmission.

34. The apparatus of claim 28 wherein said sensor pack comprises a component for data storage.

35. The apparatus of claim 28 wherein said sensor pack comprises a microprocessor.

36. The apparatus of claim 28 wherein said sensor pack comprises output connectors and/or input connectors.

37. The apparatus of claim 28 further comprising an elastic covering component.

38. The apparatus of claim 37 wherein said elastic covering component partially covers the top of the detection plate.

39. The apparatus of claim 37 wherein said elastic covering component fully covers the top of the detection plate.

40. The apparatus of claim 37 wherein said elastic covering component comprises a rubber, foam, membrane, meshed material, or net.

41. The apparatus of claim 37 wherein said elastic covering component permits transmission of sunlight.

42. The apparatus of claim 37 wherein said elastic covering component permits transmission of light having a wavelength greater than approximately 1100 nm.

43. The apparatus of claim 37 wherein said elastic covering component comprises silicone.

44. The apparatus of claim 28 wherein said detection plate comprises a solar panel.

45. The apparatus of claim 28 wherein said detection plate has an area of at least 3.5 square feet.

46. The apparatus of claim 35 wherein said microprocessor is configured to receive inputs from a sensor.

47. The apparatus of claim 35 wherein said microprocessor is configured to receive inputs from a plurality of sensors.

48. The apparatus of claim 35 wherein said microprocessor is configured to calculate hydrometeor impact data.

49. The apparatus of claim 35 wherein said microprocessor is configured to calculate hydrometeor impact data from a plurality of sensor signals.

50. The apparatus of claim 28 further comprising a supporting frame.

51. The apparatus of claim 50 further comprising a force sensor between said supporting frame and said detection plate.

52. A kit comprising a detection plate and a sensor

53. A kit comprising a detection plate and a sensor pack.

54. The kit of claim 52 further comprising an elastic covering component.

55. The kit of claim 53 further comprising an elastic covering component.

56. A kit comprising a sensor or a sensor pack and an adhesive.

57. The kit of claim 56 wherein said adhesive comprises caulk or silicone.

58. A kit comprising a sensor or a sensor pack and an elastic covering component.

59. The kit of claim 58 further comprising a composition for affixing the sensor or sensor pack to a detection plate.

60. The kit of claim 59 wherein said composition comprises an adhesive.

61. The kit of claim 59 further comprising a support frame and a force sensor.

62. The kit of claim 52 further comprising a support frame and a force sensor.

63. The kit of claim 53 further comprising a support frame and a force sensor.

64. The kit of claim 56 further comprising a support frame and a force sensor

65. A system comprising an apparatus of claim 1.

66. The system of claim 65 further comprising a computer.

67. The system of claim 65 further comprising a software component configured to receive as inputs impact data and characterize impacts.

68. The system of claim 65 comprising two or more said apparatuses.

69. The system of claim 65 comprising two or more said apparatuses distributed over a geographic region and in communication with a computer.

70. The system of claim 66 wherein the apparatus and the computer are housed in a single unit.

71. The system of claim 66 wherein the apparatus and the computer are connected by a network.

72. The system of claim 68 wherein the two or more apparatuses are distributed over a region having an area of 100 to 100,000 m².

73. The system of claim 68 wherein the two or more apparatuses are separated from one another by 10 to 10,000 m.

74. A method of detecting a hydrometeor, the method comprising:
a) providing an apparatus of claim 1; and
b) recording a signal produced by an impact on said detection plate.

75. The method of claim 74 further comprising calculating impact data from said signal.

76. The method of claim 74 further comprising performing frequency analysis on said signal.

77. The method of claim 74 further comprising transmitting said signal.

78. The method of claim 74 further comprising transmitting said impact data.

79. The method of claim 74 further comprising calibrating said apparatus.

80. The method of claim 74 wherein said providing comprises affixing a sensor to a previously installed detection plate.

81. The method of claim 74 wherein said detection plate comprises a solar panel.

82. The method of claim 74 wherein said providing comprises affixing a sensor pack to a previously installed detection plate.

83. The method of claim 74 wherein said providing comprises covering the top of the detection plate with an elastic covering component.

84. The method of claim 80 further comprising identifying a previously installed detection plate.

85. The method of claim 80 further comprising accessing a previously installed detection plate.

86. The method of claim 74 further comprising receiving a signal from one or more of a vibration sensor, a gyroscope, a magnetometer, a temperature sensor, a humidity sensor, a particulate sensor, a sensor of electromagnetic radiation, an atmospheric pressure sensor, a solar energy incidence sensor, a solar flux sensor, a wind speed sensor, a proximity sensor, or an image sensor.

87. The method of claim 74 comprising calculating hydrometeor impact data from multiple sensor signals.

88. The method of claim 74 comprising calculating hydrometeor impact data comprising hydrometeor size, hydrometeor volume, hydrometeor mass, hydrometeor momentum, hydrometeor energy, and/or hydrometeor velocity.

89. The method of claim 74 comprising calculating a distribution, range, mean, mode, and/or median of one or more of hydrometeor impact data comprising hydrometeor size, hydrometeor volume, hydrometeor mass, hydrometeor momentum, hydrometeor energy, and/or hydrometeor velocity for a plurality of hydrometeors.

90. Use of an apparatus of claim 1 to detect a hydrometeor.

91. Use of an apparatus of claim 28 to detect a hydrometeor.

92. Use of a method of claim 74 to detect a hydrometeor.

93. Use of a kit of claim 52 to assemble an apparatus in the field.

94. Use of a system of claim 65 to detect a hydrometeor.
